(19) United States
(12) Patent Application Publication
(10) Pub. No.: US 2020/0336387 A1
(43) Pub. Date: Oct. 22, 2020

(54) TOPOLOGICAL MAP PRESENTATION SYSTEM, TOPOLOGICAL MAP PRESENTATION METHOD, AND COMPUTER READABLE RECORDING MEDIUM

(71) Applicant: HITACHI, LTD., Tokyo (JP)

(72) Inventors: Katsunori SUZUKI, Tokyo (JP); Shinichi HAYASHI, Tokyo (JP)

(21) Appl. No.: 16/811,884

(22) Filed: Mar. 6, 2020

(30) Foreign Application Priority Data
Apr. 22, 2019 (JP) 2019-081215

(51) Int. Cl. H04L 12/24

(52) U.S. Cl. CPC H04L 41/147; H04L 41/12; H04L 41/145; H04L 41/22

(57) ABSTRACT

A topological map presentation system includes: a display processing unit which causes a UI unit to display a topological map having resources as nodes and connecting the nodes with lines on the basis of relations among the resources; and the UI unit which displays the topological map on a display screen, wherein the topological map provides a tiered display of each node at a height on the display screen which is determined for each resource type, the UI unit accepts a designation input of a tier to be a reference, and the display processing unit causes the topological map to be displayed on the display screen, the topological map displaying, from at least one of the nodes included in the tier designated by the designation input, nodes related to the node in upward and downward directions of the display screen.

### CROSS-REFERENCE TO PRIOR APPLICATION

This application relates to and claim the benefit of priority from Japanese Patent Application No. 2019-81215 filed on Apr. 22, 2019 the entire disclosure of which is incorporated herein by reference.

### BACKGROUND

The present invention relates to a topological map presentation system, a topological map presentation method, and a computer readable recording medium.

In IT system management, a wide variety of managerial tasks are being performed such as responding to performance failure and determining investment (capacity planning) in system resources in order to withstand future load with respect to a future load forecast of an application that runs on an IT system.

For example, when performing capacity planning, first, a resource to become a bottleneck in terms of performance with respect to a future load of an application is searched and, next, a related resource that may potentially be affected when reinforcing the resource to become a bottleneck is searched. In this manner, when performing IT system management, the entire configuration of a system is overseen while switching a resource of interest from one resource to the next.

In addition, in order to perform administrative decision-making such as making an investment decision, a state of an IT system must be comprehended from various perspectives such as a cost perspective and business impact in addition to a performance perspective. In the example of capacity planning, a location that may become a performance bottleneck of an application with a large business impact may possibly differ from a location which is costly to expand and which has a wide extent of impact. A manager in charge of administration must piece all this information together and promptly make a decision.

As described above, in order to efficiently perform management tasks of an IT system, one is required to readily oversee and comprehend the entire IT system while appropriately switching among resources of interest and perspectives. In this regard, there is a technique for topologically displaying relations among various resources that constitute an IT system.

A tree format and a graph format are known as systems for topologically displaying such relations among resources.

The tree format refers to a method in which, for example, when resource groups constituted by resource types A and B have a many-to-many relation, the relationship is visualized by overlapping the resources of one of the resource groups and representing the relations by a tree structure. The graph format refers to a method of connecting related resources with lines (edges) without displaying the resources in an overlapped manner.

In the case of the graph format, since resources do not overlap with each other, when there is only a small number of resources to be displayed, relations among individual resources can be readily comprehended by focusing on each of the resources while overseeing the entire configuration. However, when the number of resources increases, intersections of edges also increase, making it difficult to comprehend the entire configuration and relations among individual resources.

In the case of the tree format, since intersections of edges do not occur, relations among individual resources may be readily traced in a direction from a root toward leaves even when the number of resources increases. However, since the number of displayed nodes of a tree includes overlaps, the number of displayed nodes increases exponentially with respect to an increase in the number of resources. Therefore, when tracing all related resource in a direction of the root with respect to a resource that is close to a leaf, each overlap must be studied, making it difficult to trace relations. In addition, comprehending the entire configuration becomes difficult due to similar reasons.

As a technique for displaying topological information in a tree format, for example, WO 2016/103421 discloses a technique employed by a cloud configuration visualization system that is to be coupled to a cloud service delivery system in order to acquire cloud coupling information from a cloud coupling information DB using a cloud ID of a request command for cloud configuration display, identify a cloud service delivery system that acquires cloud configuration information from the cloud coupling information, acquire the cloud configuration information from the identified cloud service delivery system, and create and display a cloud configuration diagram using a component icon and coupling information of each component on the basis of the cloud configuration information.

However, the technique disclosed in WO 2016/103421 does not take into consideration readily comprehending the entire configuration and an important resource from a whole when there is a large amount of resources.

In addition, in the technique disclosed in WO 2016/103421, since a direction in which a relation among resources is traced is fixed, it is difficult to comprehend a relation in a direction from a leaf to a root with respect to a resource group having a many-to-many relation when the number of resources increases.

Therefore, with the technique disclosed in WO 2016/103421, when there is a large amount of resources, it is difficult to readily identify an important resource by overseeing the entire IT system while changing perspective and readily comprehend an overall state while changing resources of interest which are related to the important resource.

The present invention has been made in consideration of the problems described above, and an object thereof is to provide a topological map presentation system, a topological map presentation method, and a computer program which are capable of readily overseeing and comprehending a state of the entire IT system while changing perspectives and resources of interest even when the number of resources increases.

### SUMMARY

In order to solve the problems described above, a topological map presentation system according to an aspect of the present disclosure includes: a management server possessing configuration information and state information of a plurality of resources that are related to each other; a display processing apparatus which causes, on the basis of the configuration information and the state information possessed by the management server, a user interface apparatus to display a topological map having resources as nodes and connecting the nodes with lines on the basis of relations among the resources; and the user interface apparatus which displays the topological map on a display screen, wherein the topological map provides a tiered display of each node at a height on the display screen which is determined for each resource type, the user interface apparatus accepts a designation input of a tier to be a reference, and the display processing apparatus causes the topological map to be displayed on the display screen, the topological map displaying, from at least one of the nodes included in the tier designated by the designation input, nodes related to the node in upward and downward directions of the display screen.

### BRIEF DESCRIPTION OF THE DRAWINGS

FIG. 1 is a diagram for explaining an outline of a topological map presentation system according to an embodiment;

FIG. 2 is a diagram showing node types and a tiered relationship of each node in a topological map according to the embodiment;

FIG. 3 is a schematic configuration diagram showing a topological map presentation system according to an embodiment;

FIG. 4 is a diagram showing an example of a node data management table according to the embodiment;

FIG. 5 is a diagram showing an example of a group node data management table according to the embodiment;

FIG. 6 is a diagram showing an example of a tier expanded state management table according to the embodiment;

FIG. 7 is a diagram showing an example of a topological configuration state management table according to the embodiment;

FIG. 8 is a diagram showing an example of a tier definition table according to the embodiment;

FIG. 9 is a diagram showing an example of a criteria management table according to the embodiment;

FIG. 10 is a diagram showing an example of a request item management table according to the embodiment;

FIG. 11 is a diagram showing an example of topological data during a group node expansion operation according to the embodiment;

FIG. 12 is a diagram showing an example of topological data when requesting data from a topological configuration management server after a group node expansion operation according to the embodiment;

FIG. 13 is a diagram showing an example of data that is transmitted when requesting additional data from the topological configuration management server according to the embodiment;

FIG. 14 is a diagram showing an example of a query management table according to the embodiment;

FIG. 15 is a diagram showing an example of a tree drawing view table according to the embodiment;

FIG. 16 is a diagram showing an example of a query execution history management table according to the embodiment;

FIG. 17 is a diagram showing an example of a tree data management table according to the embodiment;

FIG. 18 is a sequence diagram showing an example of operations of the topological map presentation system according to the embodiment;

FIG. 19 is a flow chart showing an example of operations by an event analysis processing unit in the topological map presentation system according to the embodiment;

FIG. 20 is a flow chart showing an example of a node expansion change content calculation processing in the topological map presentation system according to the embodiment;

FIG. 21 is a flow chart showing an example of sub-tier change content calculation processing in the topological map presentation system according to the embodiment;

FIG. 22 is a flow chart showing an example of tier grouping change content calculation processing in the topological map presentation system according to the embodiment;

FIG. 23 is a flow chart showing an example of node grouping change content calculation processing in the topological map presentation system according to the embodiment;

FIG. 24 is a flow chart showing an example of topological reconfiguration content calculation processing in the topological map presentation system according to the embodiment;

FIG. 25 is a flow chart showing an example of operations by a topological data creation processing unit in the topological map presentation system according to the embodiment;

FIG. 26 is a flowchart showing an example of query creation processing in the topological map presentation system according to the embodiment;

FIG. 27 is a flow chart showing an example of operations by a topological display configuration calculation processing unit in the topological map presentation system according to the embodiment; and

FIG. 28 is a diagram showing an example of a state change of a topological map when a node expansion operation according to the embodiment is performed.

### DETAILED DESCRIPTION OF THE EMBODIMENT

Hereinafter, an embodiment of the present invention will be described with reference to the drawings. It should be noted that the embodiment described below is not intended to limit the invention as set forth in the accompanying claims and that all of the elements described in the embodiment and combinations thereof are not necessarily essential to solutions proposed by the invention.

In addition, whenever “data” is described in the present specification, the number of pieces of the data is not limited. In addition, a format of the data is not limited. Furthermore, data and the like that are archived and stored in a storage medium in a so-called tabular format are also “data” as described herein.

<Outline of Embodiment>

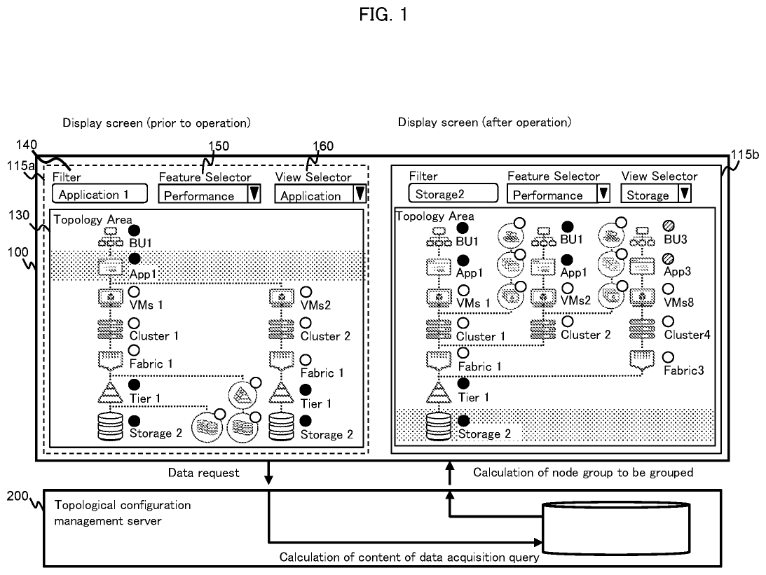

FIG. 1 is a diagram for explaining an outline of a topological map presentation system according to an embodiment of the present invention.

An outline of the present embodiment will be described with reference to FIG. 1. The topological map presentation system according to the present embodiment has a client 100 which displays a display screen 115 and a topological configuration management server 200 which stores configuration information of resource groups and applications that constitute an IT system, business units (BUs) that promote business by utilizing the applications, and the like as well as state information such as performance and which manages a topological configuration.

The display screen 115 has a topology display section 130 which displays a topological map, a filter input section 140 which inputs a display configuration of the topological map, a Feature selector 150, and a View selector 160.

Node names included in the topological map are input to the filter input section 140. When a node name is input to the filter input section 140, a filter is configured so as to form a topology constituted by a node group either directly related to the input node or indirectly related to the input node via other nodes.

The Feature selector 150 is a selector for selecting a perspective (Feature) such as “Performance Capacity” or “Cost” when a user confirms a state of a resource in relation to a content or an object of business.

The View selector 160 is a selector for selecting a type of a resource such as “Application” or “Storage” which is of particular interest to the user, which the user desires to confirm details thereof, and which becomes a source when tracing relations.

A topological map that represents relations of resources and applications constituting an IT system is displayed in the topology display section 130. The topological map presentation system according the present embodiment presents a tree-format topological map as an example of a topological map.

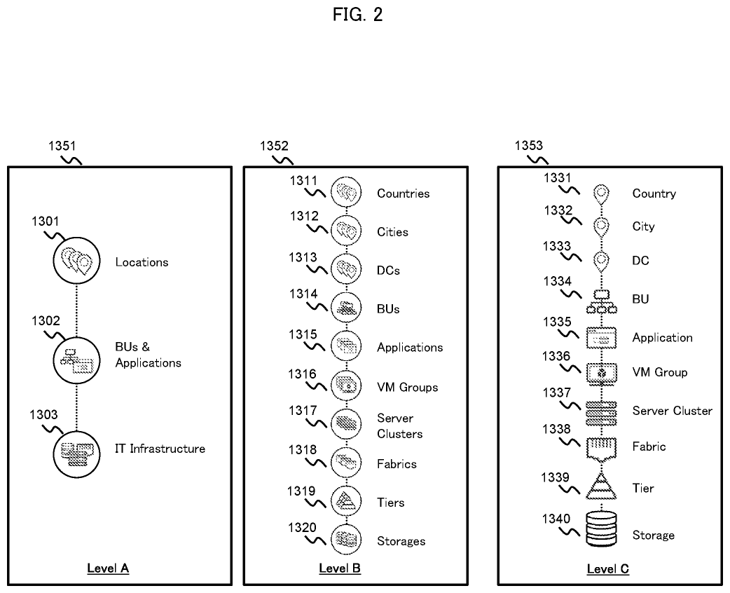

For example, a display screen (prior to operation) 115a in FIG. 1 displays a tree having each resource from a BU to a storage as a node. In addition, a display screen (after operation) 115b displays the tree after performing an operation for changing a configuration value of the View selector to “Storage”. A node constituting the tree represents a single resource or a group of a plurality of resources. Details of nodes constituting the topological map will be provided later with reference to FIG. 2.

A marker indicating a state of a resource is displayed for each node. The marker displays a state (hereinafter, a magnitude of a state may be described as “significance”) of a resource from the perspective selected by the Feature selector 150. For example, the display screen (prior to operation) 115a is a case where a value of “Performance” is configured to the Feature selector 150 in order to confirm a present performance state of an application and, in the case of an application, a state where an index for measuring performance such as a response time exceeds an abnormal determination threshold is represented by a black circle, a state where the index exceeds a warning threshold is represented by a dashed circle, and a normal state is represented by a white circle (hereinafter, the states of these three stages will be denoted by RAG (initials of a set of the respective states of Red, Amber, and Green)). It should be noted that the form of representation is merely an example and colors such as red, yellow, and green may be used instead.

On the display screen (prior to operation) 115a, since “Application” is configured to the View selector 160, a tree is constructed by tracing related resources toward upper and lower tiers from a node of each application. For example, the GUI (prior to operation) 115a represents that “App1” is related to “VM1” and “VM2, “VM1” is related to “Cluster1”, and “Cluster1” is related to “Fabric1”.

While the “Fabric1” node is related to both “Cluster1” and “Cluster2”, since a direction in which relations are traced is an upward/downward direction from “Application”, the “Fabric1” node is displayed in an overlapping manner below “Cluster1” and “Cluster2”. Therefore, with respect to “App1” which has an abnormality related to performance, by tracing related resources by tracing edges and confirming states of markers, a state of each resource from the perspective of performance can be comprehended. For example, performance of “Storage2” simultaneously related to “App1” is also in an abnormal state which is presumed to be a cause of the decline in performance of “App1”.

Supposing that a problem has actually occurred in “Storage2”, while the user next confirms a range of influence of the problem, FIG. 1 exemplifies a case where, to this end, “Storage” is selected by the View selector 160 and an operation is performed to input “Storage2” to the filter input section 140. On the display screen (after operation) 115b, since “Storage” is configured to the View selector 160, a tree is reconstructed by tracing related resources toward upper and lower tiers from the “Storage2” node. Accordingly, it is found that “App3” is also in a state where the warning threshold is exceeded.

In order to change from the display state of the display screen (prior to operation) 115a to the display state of the display screen (after operation) 115b, data related to nodes not displayed on the display screen (prior to operation) 115a must be acquired. To this end, the client 100 calculates data necessary for reconstructing topology in accordance with the operation and requests the topological configuration management server 200 for the data. The topological configuration management server 200 receives the data acquisition request, extracts corresponding data, and transmits the data to the client 100. The client 100 redraws topology on the basis of the received data.

However, when there is a large amount of resources, problems occur, such as an increase in processing time required by data access resulting in a longer time required to redraw the display screen and a large number of nodes being displayed on the display screen making it difficult to comprehend a state of each node. In consideration thereof, on the basis of information such as a structure of the topology, operation contents, areas being displayed on the screen, and the like, the topological configuration management server 200 creates a plurality of data acquisition queries with different amounts of data to be acquired and different processing times and acquires data that maximizes an amount of information on the display screen within a target time.

In addition, the client 100 calculates coordinates on the display screen of each node from the data received from the topological configuration management server 200 and configures a display order of the nodes and a grouping range of nodes with low significance so that nodes with high significance are preferentially displayed with respect to the perspective configured by the Feature selector 150. Accordingly, even in an environment where there are a large number of resources, nodes of interest with high significance can be readily comprehended while displaying the entire topology that indicates a structure of the entire IT system within a realistic processing time.

FIG. 2 is a diagram showing node types and a tiered relationship of each node in a topological map according to the present embodiment.

In FIG. 2, a node group indicated on level C 1353 includes nodes which represent individual resources and which represent units of a finest granularity. Country 1331, City 1332, and DC 1333 respectively represent a country, a city, and a data center in which Application 1335 arranged directly thereunder operates. BU 1334 represents each organization (Business Unit) that promotes business, Application 1335 represents software that is an entity of the application, VM Group 1336 represents a group of VMs (Virtual Machines), Server Cluster 1337 represents a group of physical servers, Fabric 1338 represents a group of physical switches that constitute a SAN (Storage Area Network) such as an FC (Fibre Channel), and Storage 1340 represents a storage apparatus. In addition, Tier 1339 represents a service class that classifies performance of a volume provided by the storage. Specifically, Tier 1339 represents a definition of an SLA (Service Level Agreement) related to the volume such as “Gold Tier” indicating that a maximum of 10,000 IOPS is guaranteed and actually, Tier 1339 corresponds to a volume group for which a specific SLA is promised.

In FIG. 2, a node group indicated on level B 1352 represents nodes in a case where, with respect to each resource shown on level C 1353, a plurality of nodes of a same resource type are grouped. In a topological map according to the present embodiment, the nodes shown on level B 1352 are displayed at a same height (“tier”) on the display screen as nodes of corresponding resource types shown on level C 1353. In addition, for the sake of convenience, in the following description, a name (“Application”, “City”, or the like) of each node shown on level C 1353 which corresponds to a resource type included in a tier is used as a name of the tier.

In FIG. 2, a node group indicated on level A 1351 represents nodes in a case where node sets belonging to level B and level C are grouped across a plurality of resource types. Locations 1301 is a node that groups node groups of the Country tier, the City tier, and the DC tier which represent information related to position. BUs & Applications 1352 is a node that groups node groups of the BU tier and the Application tier which are units of interest in terms of business. IT Infrastructure 1353 is a node that groups node groups of the VM Group tier, the Server Cluster tier, the Fabric tier, the Tier, and the Storage tier which are resources that constitute an IT infrastructure. For the sake of convenience, in the following description, a node that groups a plurality of node groups as shown on level A 1351 and level B 1352 will be referred to as a group node.

Since the node group shown on level A 1351 is grouped in tier units, when the node group shown on level A 1351 is being displayed, the corresponding node groups shown on level B 1352 and level C 1353 are not displayed. Therefore, when a node shown on level A 1351 is being displayed, the name of the node is displayed as a tier name.

As described earlier, with a topological map presented by the topological map presentation system according to the present embodiment, a marker indicating a state of a resource is displayed for each node. An example of a state of a group node is a state calculated on the basis of an average value or a worst value of nodes within the group. A method of the calculation may be variable depending on a Feature or a resource type.

In addition, a coupling relationship among resources shown in FIG. 2 is merely an example and a form thereof is not limited. For example, when an application is being executed directly on a server instead of on a VM, tiers may be skipped such as directly coupling the Application 1335 and the Server Cluster 1337 to each other. Furthermore, there may be cases where an application is constituted by a combination of a container, a server-less service, a SaaS service, and a PaaS service. For example, in such a case, nodes representing the container or a public cloud service may be displayed in combination with the nodes shown in FIG. 2.

### First Embodiment

<Configuration of Topological Map Presentation System According to Embodiment>

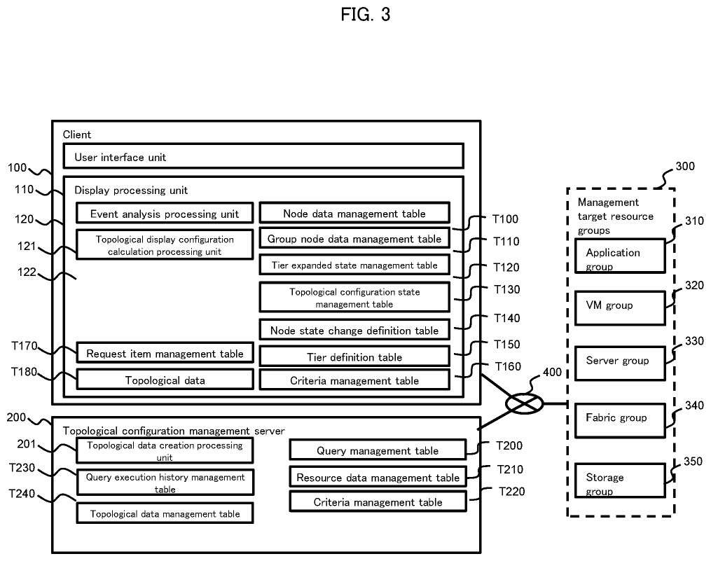

FIG. 3 is a schematic configuration diagram showing a topological map presentation system according to an embodiment of the present disclosure.

A topological map presentation system 1 according to the present embodiment has the client 100 and the topological configuration management server 200. The client 100 and the topological configuration management server 200 constituting the topological map presentation system 1 communicate via a management target resource group 300 which is a resource group to be displayed on a topological map and via a network 400.

The client 100 and the topological configuration management server 200 constituting the topological map presentation system 1 according to the present embodiment operate on a physical resource (hardware) having an information processing function and preferably operate on a computer. The computer preferably has a processing element, a storage medium, an input/output device, a communication device, and the like.

For example, the processing element is a CPU (Central Processing Unit), an FPGA (Field-Programmable Gate Array), or the like capable of various types of information processing. In addition, for example, the storage medium has a magnetic storage medium such as an HDD (Hard Disk Drive), a semiconductor storage medium such as a RAM (Random Access Memory), a ROM (Read Only Memory), or an SSD (Solid State Drive), or the like. Furthermore, a combination of an optical disk such as a DVD (Digital Versatile Disk) and an optical disk drive may also be used as the storage medium. Otherwise, known storage media such as magnetic tape media may also be used as the storage medium.

The storage medium stores data and programs. The processing element reads a program such as firmware stored in the storage medium from the storage medium upon start of operation of the topological map presentation system 1 (for example, at power-on of the client 100 or the topological configuration management server 200) and executes the program, and performs overall control by causing the computer to function as the client 100 and the topological configuration management server 200.

The client 100 and the topological configuration management server 200 may respectively operate on physically-different computers or may operate in units of computers referred to as virtual servers that are created by logically dividing a physical computer. Alternatively, the client 100 and the topological configuration management server 200 may operate in units of tasks (also referred to as processes or containers) to be executed on one computer or a on a cluster of a plurality of computers.

The client 100 has a user interface unit (a user interface apparatus, hereinafter described by an abbreviation “UI unit”) 110 which displays a topological map, various types of configuration value input selectors, and the like and a display processing unit (a display processing apparatus) 120 which performs processing for displaying a topological map on the UI unit 110. The client 100 may be a Web application that operates on a web browser or may be an independent desktop application.

The display processing unit 120 has an event analysis processing unit 121, a topological display configuration calculation processing unit 122, and a node data management table T100, a group node data management table T110, a tier expanded state management table T120, a topological configuration state management table T130, a node state change definition table T140, a tier definition table T150, a criteria management table T160, a request item management table T170, and topological data T180 which are used in processes performed by the processing units.

The event analysis processing unit 121 identifies, on the basis of input accepted by the UI unit 110, a content of a change in a structure of a topological map and a data acquisition request to be sent to the topological configuration management server 200. In other words, the event analysis processing unit 121 identifies, in correspondence with a topology operation event by the user, a content of a change in the structure of a topological map and data to be additionally acquired for the change.

The topological display configuration calculation processing unit 122 calculates a grouping range and a display position of a node in a display area of the display screen 115 on the basis of data sent from the topological configuration management server 200. In other words, on the basis of data acquired from the topological configuration management server 200, the topological display configuration calculation processing unit 122 calculates a range of grouping of nodes to be actually displayed, coordinates of the nodes, and the like.

The topological configuration management server 200 has a topological data creation processing unit 201 which performs processing of determining data to be actually acquired in response to a data acquisition request from the client 100 and a query management table T200, a resource data management table T210, a criteria management table T220, a query execution history management table T230, and a topological data management table T240 which are used when performing the processing of determining data. Among these tables, since a content of the criteria management table T220 is the same as that of the criteria management table T160 included in the display processing unit 120 of the client 100, a description thereof will be omitted.

In the topological map presentation system 1 according to the present embodiment, the client 100 does not permanently hold data for displaying a topological map and the data is managed by the topological configuration management server 200 in a centralized manner. For this reason, the topological configuration management server 200 also holds a content of an operation performed with respect to the client 100 and data of a structure of a topological map being displayed. Therefore, by having the topological configuration management server 200 hand over such data to the client 100, the topological map can be continuously displayed even when the client 100 performs initialization. In addition, since there may be cases where a plurality of clients is present such as a case where a client is realized by a web browser, the topological configuration management server 200 holds a state of each client as session information.

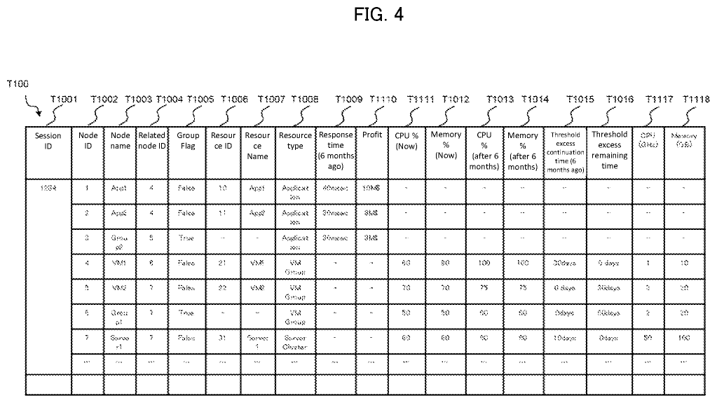

FIG. 4 is a diagram showing an example of the node data management table T100 according to the present embodiment.

The node data management table T100 is a table that holds, with respect to a node constituting the topological map, relation information between the node and other nodes, state information such as a performance of a resource which the node corresponds to, and the like.

The node data management table T100 has a session ID T1001, a node ID T1002, a node name T1003, a related node ID T1004, a group flag T1005, a resource ID T1006, a resource name T1007, a resource type T1008, and fields including various types of state information.

The session ID T1001 is an ID for holding a state of topology in a distinguished manner for each client 100 or each user when a plurality of clients 100 or a plurality of users requests topological information from the topological configuration management server 200.

The node ID T1002 is an ID for identifying a node, and the node name T1003 is a name of the node to be displayed on the UI unit 110. The related node ID T1004 holds an ID of a node to be coupled to the node displayed in a downward direction on the UI unit 110. The group flag T1005 is a field that holds whether or not the node is a group node.

The resource ID T1006 is an ID of a resource which the node corresponds to and corresponds to a resource ID T2101 of the resource data management table T210 to be described later. In addition, when the node is a group, “-” indicating that there is no corresponding resource is stored. The resource type T1008 is a field for holding information representing a type of a resource and corresponds to a tier name of level C 1353 shown in FIG. 2.

A response time T1009 to Memory (GB) T1018 represent an example of state information such as performance of a resource which the node corresponds to. The response time T1009 is an API response time of an application, and a profit 11010 is a profit to which the application contributes. CPU % (Now) T1011 and Memory % (Now) T1012 represent a present CPU usage rate and a present memory usage rate.

CPU % (After 6 Months) T1013 and Memory % (After 6 Months) T1014 represent a CPU usage rate and a memory usage rate after six months.

A threshold excess continuation time (6 Months Ago) T1015 represents a continuation time at a time point of six months after a performance value prediction of the CPU usage rate, the memory usage rate, or the like exceeds an abnormality determination threshold. A threshold excess remaining time T1016 represents an estimated remaining time until a performance value such as the CPU usage rate or the memory usage rate exceeds the abnormality determination threshold.

CPU (GHz) T1117 and Memory (GB) T1118 respectively represent total amounts of a CPU resource and a memory resource which are assigned to a VM group or a Server Cluster.

These pieces of state information are merely an example and other information may be included. In addition, the time point of six months which is described in the present embodiment is merely an example of future prediction information and information of other time points may be included. In order to calculate a prediction value, a known machine learning algorithm which learns previous data and performs a regression analysis may be used.

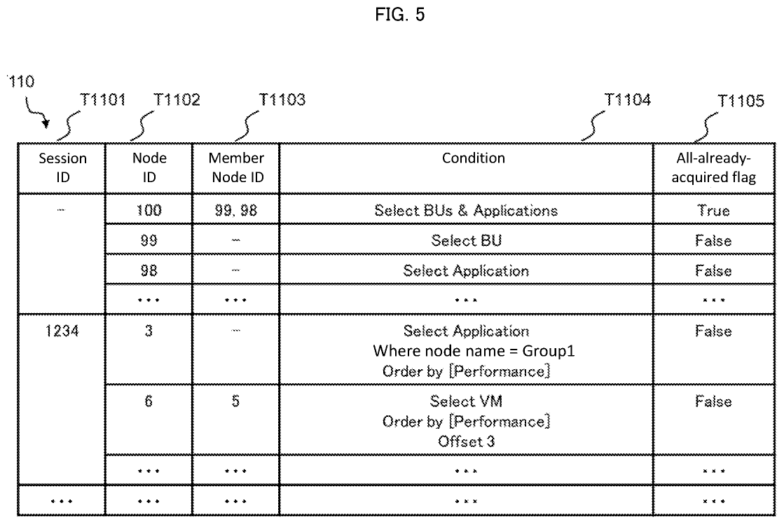

FIG. 5 is a diagram showing an example of the group node data management table T110 according to the present embodiment.

The group node data management table T110 is a table that holds information such as a configuration of a group node.

The group node data management table T110 has a session ID T1101, a node ID T1102, a member node ID T1103, a condition T1104, and an all-already-acquired flag T1105.

The session ID T1101 has a same content as the session ID T1001 of the node data management table T100 shown in FIG. 4. The node ID T1102 is an ID of a group node, and the member node ID T1103 is an ID of a node included in the group. These IDs correspond to the node ID T1002 field of the node data management table T100.

The condition T1104 is a field that holds a condition of grouping. In an example shown in FIG. 5, a set of conditional expressions is indicated by expressions similar to SQL. For example, “Select Application” indicates a node set of which a resource type is Application, “Where node name=Group1” indicates a node set of which a relation with a node having a node name of “Group1” is included in the related node ID T1004, “Ordered by [Performance]” indicates an alignment according to a criterion that Feature is “Performance”, and “Offset 3” indicates a set of 3rd and subsequent nodes after the alignment.

The all-already-acquired flag T1105 is a flag indicating whether or not all of the pieces of information of resources matching the condition 11104 have been acquired from the topological configuration management server 200.

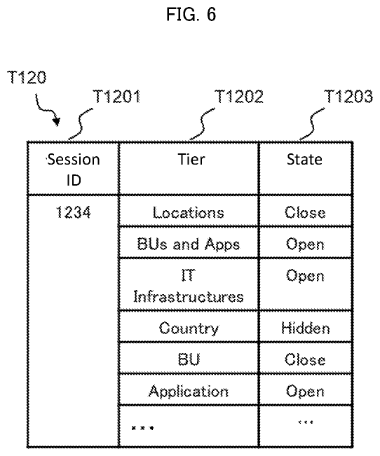

FIG. 6 is a diagram showing an example of the tier expanded state management table T120 according to the present embodiment.

The tier expanded state management table T120 is a table that manages, with respect to a tier of a node of a topological map, a state of whether or not grouping is perform in units of the tier.

The tier expanded state management table 1120 has a session ID T1201, a tier T1202, and a state T1203.

The session ID T1201 has a same content as the session ID T1001 of the node data management table T100 shown in FIG. 4. The tier T1202 represents a name of a tier that may be displayed on the UI unit 110 (in the present embodiment, node names of level A 1351 and level C 1353 shown in FIG. 2). In addition, the state T1203 stores a value of a state (“Open”) where grouping is not performed in tier units and each node belonging to a tier is being displayed or a state (“Close”) where either grouping is performed in tier units or a plurality of tiers are collectively grouped.

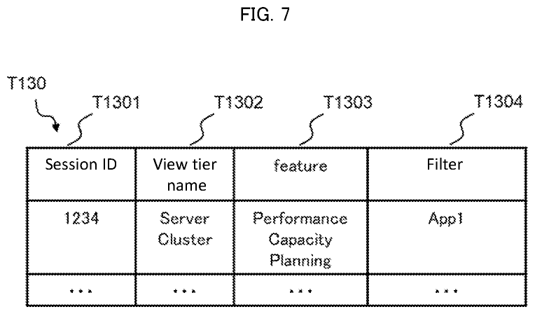

FIG. 7 is a diagram showing an example of the topological configuration state management table T130 according to the present embodiment.

The topological configuration state management table T130 is a table that stores values of configuration values (filter, View, Feature) of a topological map.

The topological configuration state management table T130 has a session ID T1301, a View tier name T1302, a Feature T1303, and a filter T1304.

The session ID T1201 has a same content as the session ID T1001 of the node data management table T100 shown in FIG. 4. A value of the View tier name T1302 corresponds to a value of the tier name T1501 field of the tier definition table T150, and a value of the Feature T1303 corresponds to a value of the Feature T1601 field of the criteria management table T160. In addition, a value of the filter T1304 corresponds to a value of the node name T1003 field of the node data management table T100.

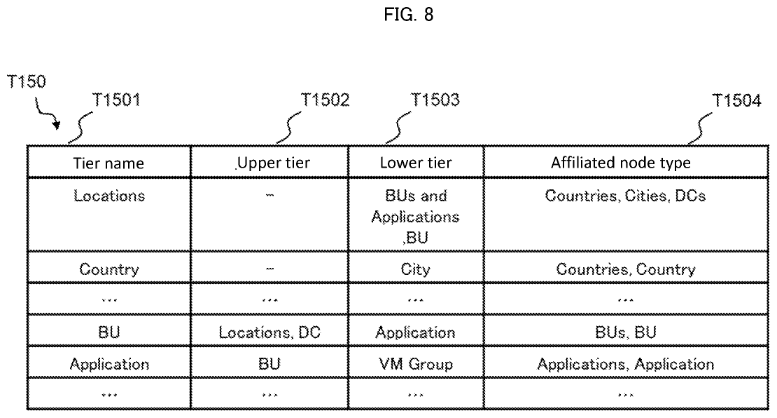

FIG. 8 is a diagram showing an example of the tier definition table T150 according to the present embodiment.

The tier definition table T150 is a table which holds information on an order among tiers on the UI unit 110 and nodes included in the tiers and which is used to calculate display positions of each tier and each node when displaying a topological map on the UI unit 110.

The tier definition table T150 has a tier name T1501, an upper tier T1502, a lower tier T1503, and an affiliated node type T1504.

The upper tier T1502 is a tier to be displayed at a position above the tier represented by the tier name T1501 on the UI unit 110, and the lower tier T1503 is a tier to be displayed at a position below the tier represented by the tier name T1501 on the UI unit 110.

The affiliated node type T1504 indicates a type of a node belonging to the tier represented by the tier name T1501 when grouping is performed. For example, with respect to a Locations tier, node types of Locations, Countries, Country, Cities, City, DCs, and DC are stored.

Among these node types, when a tier on level A 1351 shown in FIG. 2 such as the Locations tier is displayed, since the state T1203 field is “Close” with respect to a relevant row of the tier expanded state management table T120, the Country tier, the City tier, and the DC tier are not displayed. Therefore, while only the node type of Locations is used when calculating node positions in order to display nodes on the UI unit 110, conversely, when City nodes are selected and the nodes are grouped by units of the Location tier, a node type of a grouping range is determined using information of the affiliated node type T1504.

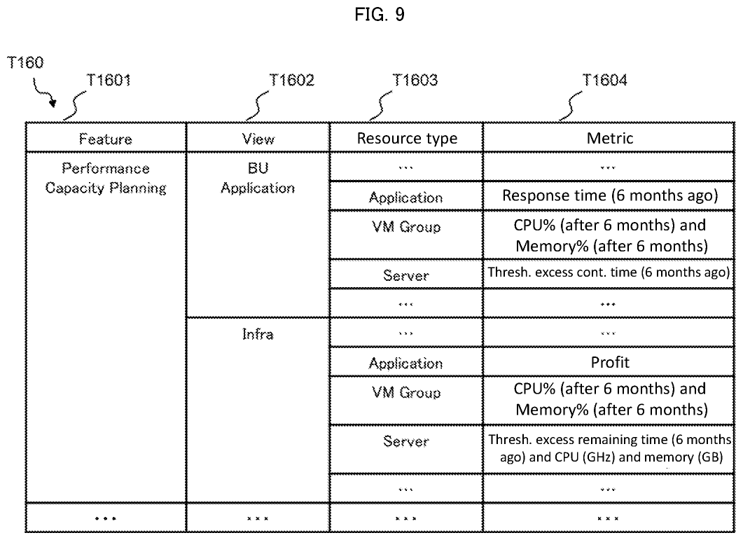

FIG. 9 is a diagram showing an example of the criteria management table T160 according to the present embodiment.

The criteria management table T160 is a table for holding metrics to be selected when calculating an significance of a node of each resource type for each value of Feature and View.

The criteria management table 1160 has a Feature T1601, a View T1602, a resource type T1603, and a metric T1604.

The Feature T1601 is a value of a Feature that may be configured to the Feature Selector 150, and the View T1602 is a tier name that may be configured to the View Selector 160.

The example shown in FIG. 9 represents a case (“Performance Capacity Planning”) where capacity planning is performed from a performance perspective so that the performance falls below the abnormality determination threshold at a future time point. At this point, when the View is “Application”, a manager confirms IT infrastructure related to an application on a topological map in order to identify a causal IT infrastructure when performance (response time) of the application exceeds the abnormality determination threshold at a future time point.

Therefore, when the View is “Application” and the resource type T1603 is Server Cluster, an elapsed time from the Server Cluster exceeding the abnormality determination threshold is designated in the metric T1604.

In contrast, when the View is “Server Cluster”, the manager displays a topological map in order to minimize a risk of depletion of performance of the Server Cluster so that the application can be operated in a stable manner. Therefore, a remaining time until the abnormality determination threshold is exceeded is designated in the metric T1604.

In addition, when performing enhancement, since an amount of resources that need to be added changes depending on an amount of existing resources such as a CPU and a memory and affects cost, an amount of resources of the CPU and the memory is also designated in the metric T1604. For example, these criteria may be first sorted by an abnormality determination threshold excess time which is designated above and then sorted using a resource amount of the CPU and the memory as a second sort key.

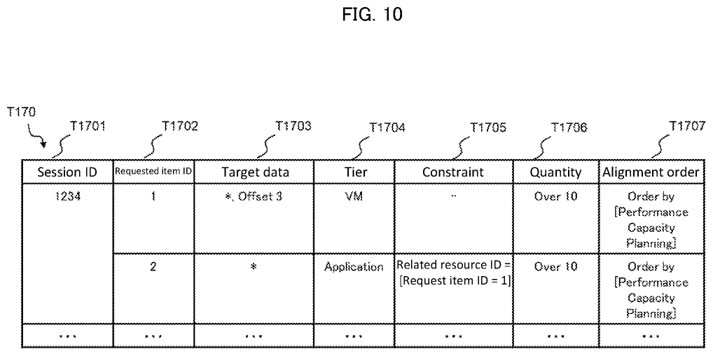

FIG. 10 is a diagram showing an example of the request item management table T170 according to the present embodiment.

The request item management table T170 is a table that holds, when the user performs an operation with respect to a topological map, data acquisition items that must be requested to the topological configuration management server 200 in order to change a display of the topological map. When acquiring data from the resource data management table T210, the request item management table T170 holds information for limiting data to be acquired.

The request item management table T170 has a session ID T1701, a request item ID T1702, target data T1703, a tier T1704, a constraint T1705, a quantity T1706, and an alignment order T1707.

The session ID T7101 has a same content as the session ID T1001 of the node data management table T100 shown in FIG. 4. The request item ID T1702 is an identification ID of a request for acquiring a set of data such that data can be acquired from a database by one data acquisition query.

The target data T1703 to the alignment order T1707 are examples of information for limiting acquired data. An example shown in FIG. 10 is described by expressions similar to SQL.

The target data T1703 indicates a range of data to be acquired. As an example, when the identification ID shown in the request item ID T1702 is “1”, the range of data to be acquired is all items with respect to the 3rd from the top and subsequent pieces of data (“*, Offset 3”). The tier T1704 designates a tier which data to be acquired belongs to. The constraint T1705 is a condition for limiting data to be acquired. For example, “related resource ID=[request item ID=1]” indicates that the resource ID T2101 of data to be acquired by the request item ID=1 is data of a resource designated in the related resource ID T2104.

The quantity T1706 indicates the number of pieces of data to be acquired. For example, a minimum number of pieces may be designated like “Over 10”. The alignment order T1707 is a criterion when aligning data. When designated by Feature as in the case of “[Performance Capacity Planning]”, the criteria management table T160 is referred to and data is aligned by the corresponding metric T1604.

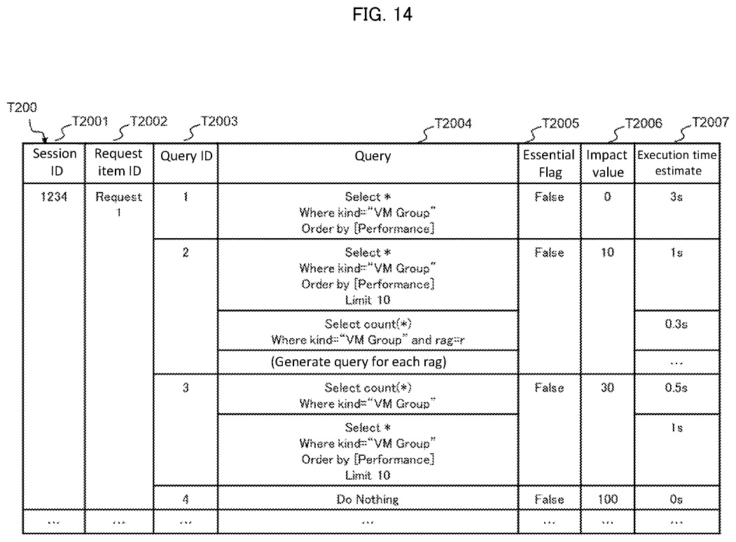

FIG. 14 is a diagram showing an example of the query management table T200 according to the present embodiment.

The query management table T200 is a table that manages a query group for actually acquiring data from the resource data management table T210.

The query management table T200 has a session ID T2001, a request item ID T2002, a query ID T2003, a query T2004, an essential flag T2005, an impact value T2006, and an execution time estimate T2007.

The session ID T2001 has a same content as the session ID T1001 of the node data management table T100 shown in FIG. 4. The request item ID T2002 corresponds to the request item ID T1702 field of the request item management table T170. The query ID T2003 is an ID for identifying a query group for satisfying a corresponding request item.

The query T2004 represents an individual data acquisition query (in an example shown in FIG. 14, indicated by an SQL expression).

The essential flag T2005 is a flag indicating whether or not a query must be executed such as data that must always be displayed. The impact value T2006 indicates a magnitude of impact of an item or the like that becomes absent from a display of a topological map when, hypothetically, the query group with the query ID T2003 is executed with respect to the data acquisition request with the request item ID T2002 and data is acquired and transmitted to the client 100. The execution time estimate T2007 is a time estimated when the corresponding query T2004 is executed.

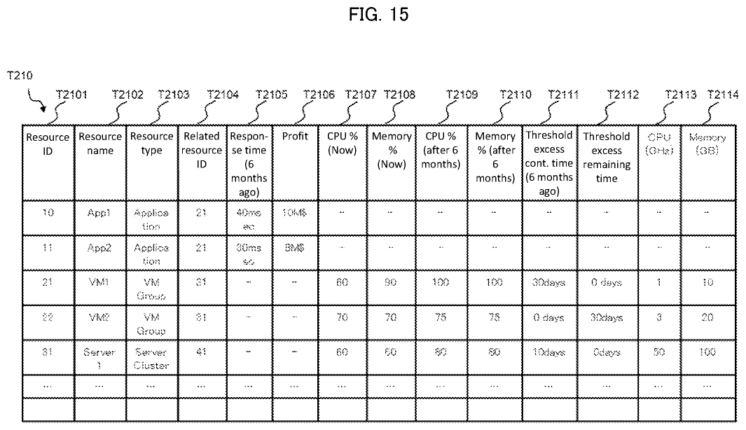

FIG. 15 is a diagram showing an example of the resource data management table T210 according to the present embodiment.

The resource data management table T210 is a table that holds relation information between resources and state information such as performances of the resources.

The resource data management table T210 has a resource ID T2101, a resource name T2102, a resource type T2103, a related resource ID T2104, and fields including various types of state information.

The resource ID T2101 is an identification ID of a resource, and the resource name T2102 is a name of the resource. The resource type T2103 is a field for holding information representing a type of a resource and corresponds to a tier name of level C 1353 shown in FIG. 2. The related resource ID T2104 holds an ID of a resource to be coupled to the resource in a downward direction on the display screen 115 of the UI unit 110.

A response time T2105 to Memory (GB) T2113 are pieces of information similar to the response time T1009 to Memory (GB) T1018 of the node data management table T100.

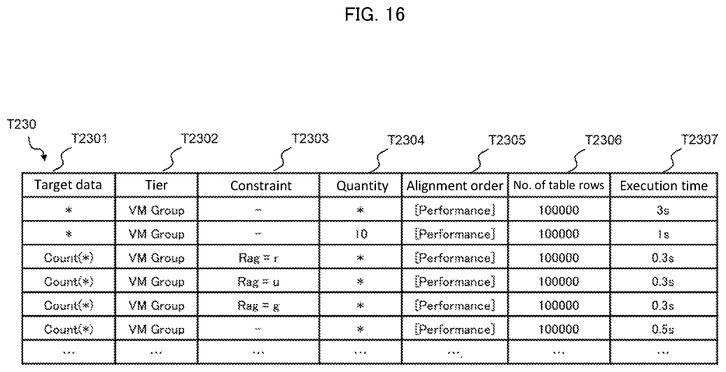

FIG. 16 is a diagram showing an example of the query execution history management table T230 according to the present embodiment.

The query execution history management table T230 is a table for holding fundamental data for calculating an estimate of a query execution time.

The query execution history management table T230 has target data T2301, a tier T2302, a constraint T2303, a quantity T2304, an alignment order T2305, number of table rows T2306, and an execution time T2307.

The target data T2301 to the alignment order T2305 respectively correspond to the target data T1703 to the alignment order T1707 of the request item management table T170 and are information for limiting data to be acquired when acquiring data from the resource data management table T210.

For example, in SQL, a second row of the query execution history management table T230 corresponds to “Select * from resource data management table T210 where resource type=VM Group ordered by [Performance] limit 10”. The number of table rows T2306 represents the number of rows of the resource data management table T210 during query execution. The execution time T2307 is time actually required by query execution.

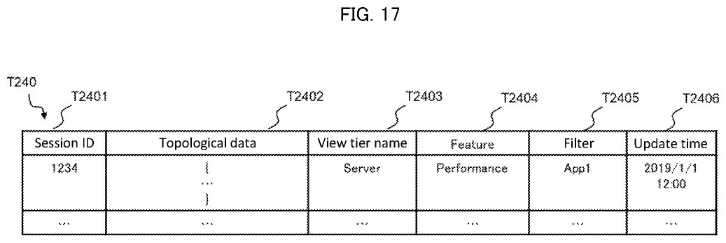

FIG. 17 is a diagram showing an example of the topological data management table T240 according to the present embodiment.

The topological data management table T240 is a table for holding a state of a topological map together with session information. The present table is updated when the user performs an operation with respect to the UI unit 110 to change a state of a topological map and a query is made with respect to the topological configuration management server 200.

The topological data management table T240 has a session ID T2401, topological data T2402, a View tier name T2403, a Feature T2404, a filter T2405, and an update time point T2406.

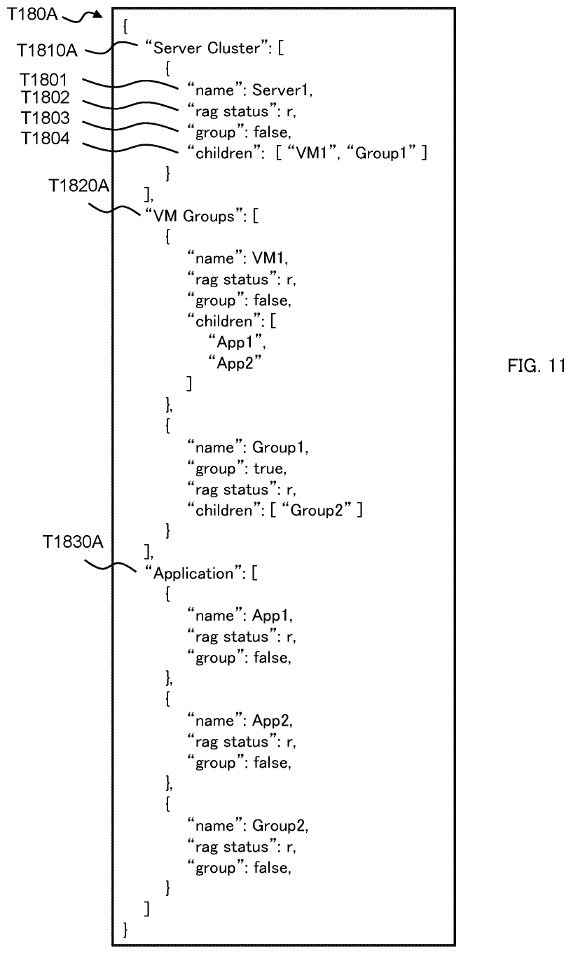

The session ID T2401 has a same content as the session ID T1001 of the node data management table T100 shown in FIG. 4. The topological data T2402 is data indicating a configuration of a topological map and, for example, data with a JSON (JavaScript Object Notation) format as shown in FIG. 11 to be described later. The View tier name T2403 to the filter T2405 respectively correspond to the View tier name T1302 to the filter T1304 of the topological configuration state management table.

<Operations of Topological Map Presentation System According to Embodiment>

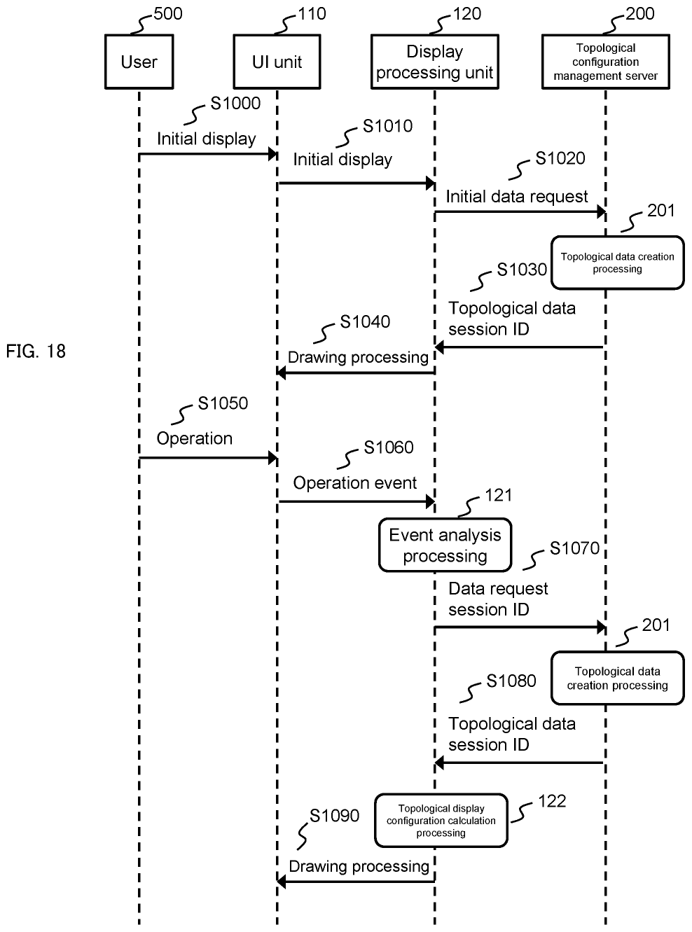

FIG. 18 is a sequence diagram showing an example of operations of the topological map presentation system 1 according to the present embodiment. The sequence diagram of FIG. 18 shows an outline of a processing sequence until a topological map is displayed on the UI unit 110.

First, a case where the user initially displays a topological map with the UI unit 110 will be described.

When the user initially displays a topological map with the UI unit 110 (S1000), the UI unit 110 issues an initial display request of the topological map to the display processing unit 120 (S1010), and in response thereto, the display processing unit 120 requests the topological configuration management server 200 for initial topological data (S1020).

When the topological configuration management server 200 receives the request for initial topological data, the topological data creation processing unit 201 creates the initial topological data. In addition, the topological configuration management server 200 returns the generated topological data and a session ID to the display processing unit 120 (S1030). The display processing unit 120 calculates display coordinates and the like of each node with respect to the received topological data and performs drawing processing of the display screen 115 (S1040).

S1050 to S1090 represent a processing sequence in a case where a configuration change operation by the user is performed with respect to the topological map. Examples of the configuration change operation by the user include a group node expansion operation, an operation of grouping nodes in tier units, an operation of grouping nodes in RAG units, an operation of changing View, and an operation of changing Feature.

When a user 500 performs an operation (S1050), the UI unit 110 identifies a content of the operation and a node that is a target of the operation and notifies the display processing unit 120 of an occurrence of an operation event (S1060). When the display processing unit 120 is notified of the occurrence of an operation event, first, the event analysis processing unit 121 executes processing for changing a mode of the topological map. Accordingly, data that needs to be requested is identified and a request for topological data acquisition is transmitted to the topological configuration management server 200 (S1070).

When the topological configuration management server 200 receives the request, the topological data creation processing unit 201 updates the topological data and returns the topological data to the display processing unit 120 (S1080). Next, on the basis of the topological data received from the topological configuration management server 200, the topological display configuration calculation processing unit 122 of the display processing unit 120 calculates grouping and the like of nodes with relatively low significance so that significant nodes are displayed in a left part of a screen which the user can readily confirm without scrolling the screen when displaying the topological data on the UI unit 110. Subsequently, the topological display configuration calculation processing unit 122 performs drawing processing of the topological map on the basis of final display data of the topological map (S1090).

It should be noted that processes similar to those of S1060 to S1090 are also performed when redrawing at the UI unit 110 and the like. In this case, since there is no need to change the mode of the topological map, the UI unit 110 transmits the session ID without a data acquisition request to the topological configuration management server 200. The topological configuration management server 200 refers to the topological data management table T240 on the basis of the received session ID and transmits various types of topological map configuration information to the client 100. Based on the received topological data and the topological map configuration information, the client 100 creates display data of the topological map and draws the topological map on the UI unit 110.

Next, an example of operations of the event analysis processing unit 121, the topological data creation processing unit 201, and the topological display configuration calculation processing unit 122 will be described using an example of a group node expansion operation.

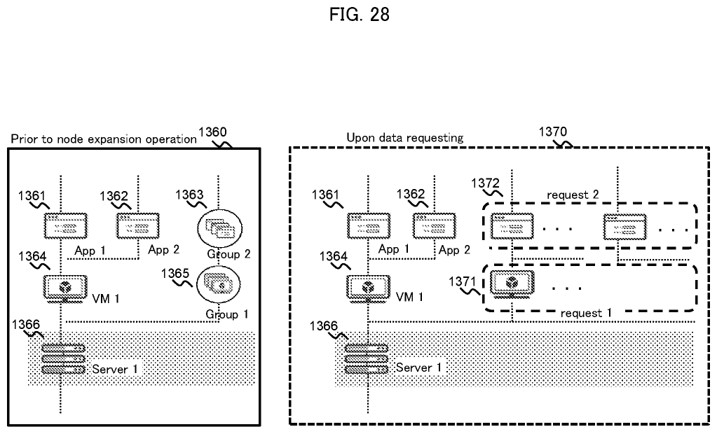

FIG. 28 is a diagram showing an example of a state change of a topological map when a node expansion operation according to the present embodiment is performed.

A left part of FIG. 28 represents an example of a topological map 1360 prior to a node expansion operation. In the present example, Server Cluster is configured as View and a tree structure with Server Cluster as a source is formed.

With respect to “Server1” 1366, related VM Groups are “VM1” 1364 and “Group1” 1365. Applications related to “VM1” are “App1” 1361 and “App2” 1362, and a Group related to “Group1” 1365 is “Group2” 1363.

A right part of FIG. 28 represents an example of a topological map 1370 when an operation for expanding “Group1” 1365 is performed.

Expanding “Group1” 1365 causes individual nodes to be displayed. A data acquisition request for a node group which is included in “Group 1” and which is necessary for the expansion is a range indicated by “Request 1” 1371. At the same time, with respect to “Group 2” 1363, since a parent node is refined, nodes of Application related to each node that constitutes “Group 1” must be displayed. A data acquisition request of the node group of Application related to each node that is a result of “Request 1” is a range indicated by “Request 2”.

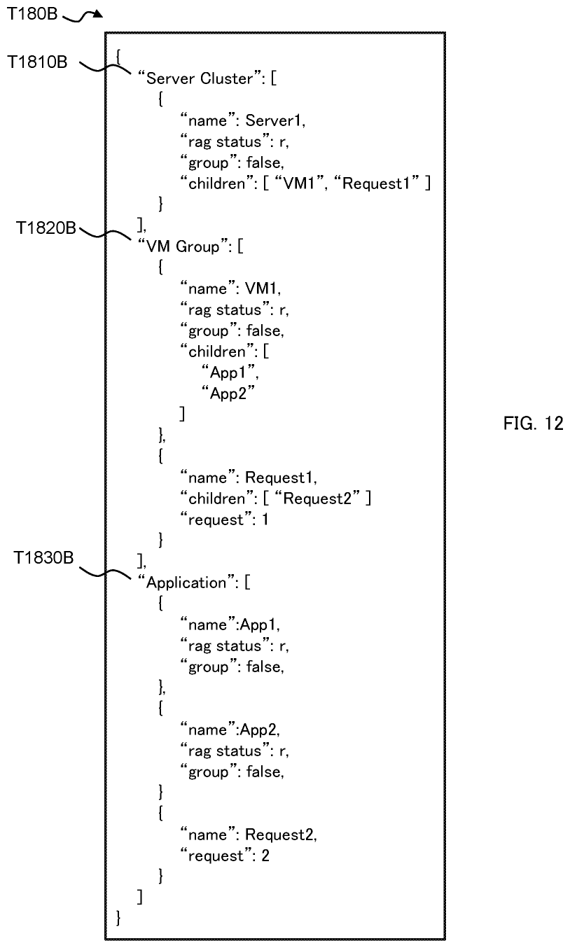

FIGS. 11 and 12 show an example (JSON format) of topological data T180 of the topological map shown in FIG. 28.

FIG. 11 is a diagram showing an example of topological data during a group node expansion operation according to the present embodiment, and FIG. 12 is a diagram showing an example of topological data when requesting data from a topological configuration management server after a group node expansion operation according to the present embodiment.

The topological data shown in FIG. 11 is data T180A representing a topological map prior to a group node expansion operation shown in a left part of FIG. 28, and the topological data shown in FIG. 12 is topological data T180B when making an inquiry to the topological configuration management server 200 after a group node operation shown in a right part of FIG. 28.

Topological data is used when the client 100 displays a topological map as an internal representation of the topological map to be displayed or as data which is held together with session information by the topological configuration management server 200 and which is used to recreate the topological map when information held by the client 100 is lost.

The topological data T180A shown in FIG. 11 is an object including a plurality of members having a tier name as a key and an array of “node information” as a value. For example, in topological data T180A, a member T1810A indicating a node group of the “Server Cluster” tier, a member T1820A indicating a node group of the “VM Group” tier, and a member T1830A indicating a node group of the “Application” tier are illustrated.

“Node information” has a node name T1801, a RAG state T1802, a flag T1803 indicating whether or not the node is a Group node, and a name (Children) T1804 of nodes related to the node.

Examples of a value of the RAG state T1802 are “r” (Red), “a” (Amber), and “g” (Green). In addition, since a direction in which relations among nodes can be traced on the topological map displayed on the UI unit 110 changes depending on a value of View, a value of Children T1804 is determined by the value of View. For example, in the case of a node of a tier designated as View, since relations can be traced toward nodes in both upward and downward directions, Children T1804 includes names of nodes belonging to upper and lower tiers. In contrast, in the case of a node positioned at a leaf, since there is no destination node to be traced, either Children T1804 itself does not exist or has an empty array as a value. Hereinafter, for the sake of brevity, a node to be a source when tracing a relation will be described as a parent node and a destination node when tracing a relation will be described as a child node.

The topological data T180B shown in FIG. 12 is topological data to be handed over to the topological configuration management server 200 when making a data acquisition request to the topological configuration management server 200 after expanding “Group 2” 1365.

Therefore, not all data of nodes necessary as a topological map have been filled. Instead, for example, the node group (T1820B) of “VM Group” is filled by a temporary node indicating the data acquisition request item “Request 2” and the node group (T1830B) of “Application” is filled by a temporary node indicating the data acquisition request item “Request 2”.

In addition, each node is filled with a value of Children T1804 which indicates a relation between nodes so as to include “Request 1” and “Request 2”. Accordingly, after subsequently acquiring data from the topological configuration management server 200, topological map data can be generated by replacing the temporary nodes of “Request 1” and “Request 2” with actual nodes.

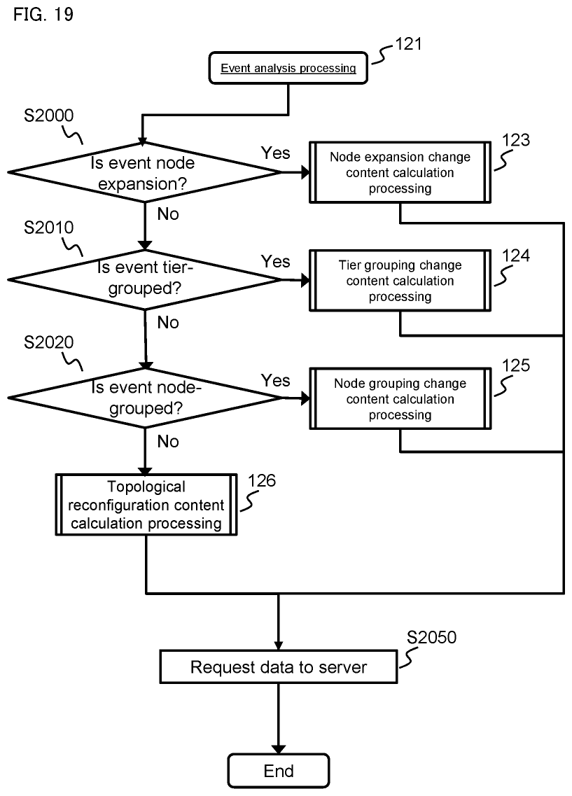

When the user performs an operation with respect to a topological map, the event analysis processing unit 121 performs processing of calculating a content of change to topological data in accordance with the operation. FIG. 19 shows a flowchart of processes executed by the event analysis processing unit 121.

FIG. 19 is a flow chart showing an example of operations by the event analysis processing unit 121 in the topological map presentation system 1 according to the present embodiment.

First, the event analysis processing unit 121 performs change content calculation processing of topological data in accordance with a received operation event. First, the event analysis processing unit 121 determines whether or not the operation event is a node expansion operation (S2000), and when the event analysis processing unit 121 determines that the operation event is a node expansion operation (Yes in S2000), the event analysis processing unit 121 executes node expansion change content calculation processing 123.

In contrast, when the event analysis processing unit 121 determines that the operation event is not a node expansion operation (No in S2000), the event analysis processing unit 121 next determines whether or not the operation event is an operation of grouping node groups in tier units (S2010). When the event analysis processing unit 121 determines that the operation event is an operation of grouping node groups in tier units (Yes in S2010), the event analysis processing unit 121 executes tier grouping change content calculation processing 124.

In contrast, when the event analysis processing unit 121 determines that the operation event is not an operation of grouping node groups in tier units (No in S2010), the event analysis processing unit 121 next determines whether or not the operation event is an operation of grouping node groups in units other than tiers (S2020). When the event analysis processing unit 121 determines that the operation event is an operation of grouping node groups in units other than tiers (Yes in S2020), the event analysis processing unit 121 executes node grouping change content calculation processing 125. In contrast, when the event analysis processing unit 121 determines that the operation event is not an operation of grouping node groups in units other than tiers (No in S2020), the event analysis processing unit 121 executes topological reconfiguration content calculation processing 126.

After executing the change content calculation processes (124 to 128) of each piece of topological data, the event analysis processing unit 121 transmits the content of the operation event, topological data after the operation event and, when necessary, a data acquisition request to the topological configuration management server 200 (S2050).

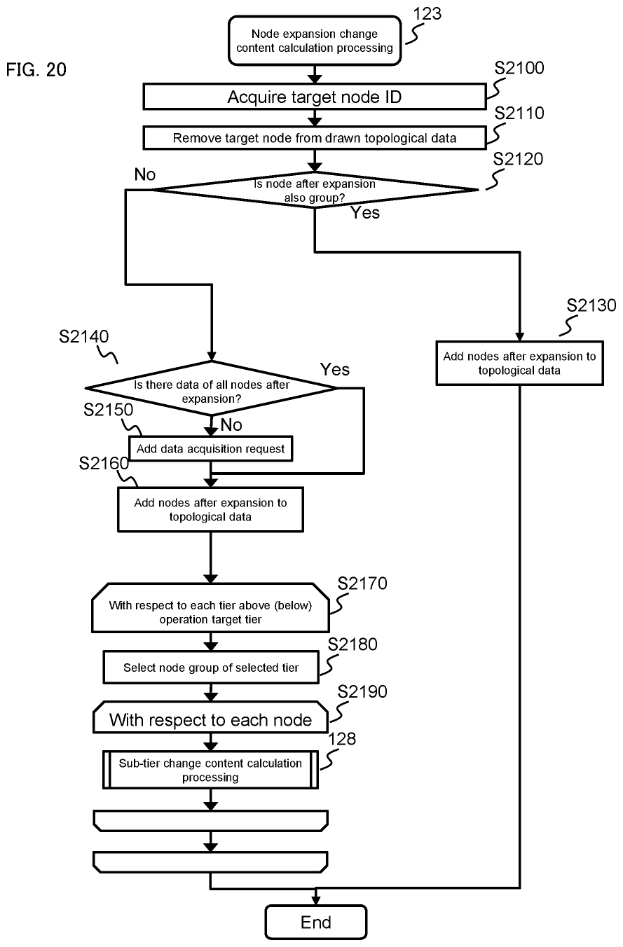

FIG. 20 is a flowchart showing an example of the node expansion change content calculation processing 123 in the topological map presentation system 1 according to the present embodiment.

In the node expansion change content calculation processing 123, when the event analysis processing unit 121 acquires an ID of a node that is an operation target (S2100), first, the node that is the operation target is removed from topological data 1180 (S2110). Next, the event analysis processing unit 121 inserts a node group after group expansion into the topological data T180.

At this point, when the operated node type is a group node created by further grouping a group node such as “Locations”, “BUs & Applications”, or “IT Infrastructures”, there is no need to search for a node to be newly displayed by a node expansion operation by tracing a relation. Therefore, the event analysis processing unit 121 determines whether or not the node after expansion is also a group node (S2120), and when the event analysis processing unit 121 determines that the node after expansion is also a group node (Yes in S2120), the event analysis processing unit 121 refers to the member node ID T1103 of the group node data management table T110, reflects the node after node expansion onto topological data, and ends the processing (S2130).

In contrast, when the node after expansion is not a group node (No in S2120), the event analysis processing unit 121 must search for a node to be newly displayed on the topological map by tracing a relation from a parent node of a group node. In addition, a grandchild node related to the node to be newly displayed, a descendant node related to the grandchild node, and so on must be gradually scanned with respect to each tier and a subtree constituted by the group node to be expanded and subordinate nodes thereof must be reconstructed.

To this end, the event analysis processing unit 121 expands a group node that is anode expansion operation target (S2140 to S2160). First, the event analysis processing unit 121 refers to a row corresponding to the group node that is the node expansion operation target in the group node data management table T110.

At this point, the event analysis processing unit 121 determines whether or not the all-already-acquired flag T1105 of the row is True (S2140), and when the event analysis processing unit 121 determines that the all-already-acquired flag T1105 of the row is not True (No in S2140), the event analysis processing unit 121 determines that additional data needs to be acquired in order to display nodes after the expansion. To this end, the event analysis processing unit 121 refers to the condition field T1104, creates a data acquisition request with a same content, and stores the data acquisition request in the request item management table T170 (S2150). In contrast, when the event analysis processing unit 121 determines that the all-already-acquired flag T1105 is True (Yes in S2140), the process is shifted to S2160 as-is.

In addition, when there is node information of the member node ID T1103 of the row and a request item created in S2150, the event analysis processing unit 121 reflects information of a temporary node indicating a content of the request item onto topological data (S2160).

Next, in a direction of separation on the display screen 115 from a tier where a scan is to be started or, in other words, in a direction of a leaf, the event analysis processing unit 121 sequentially executes processes of S2170 to S2190 with respect to each tier. Accordingly, in a state after the nodes are expanded, topology is reconstructed with respect to descendant nodes of the node after expansion which is selected in S2140 to S2160.

First, from a node group of an operation target tier that has been selected (S2170), the event analysis processing unit 121 selects a parent node of an operation target group node or, when the operation target group node belongs to the View tier, selects a node group of a member that constitutes the operation target group node (S2180). In addition, the event analysis processing unit 121 executes the sub-tier change content calculation processing 128 with respect to each selected node. In next and subsequent loops, a child node of each node selected in the previous loop is selected in S2180. Accordingly, a child node group of each node is sequentially reflected onto topological data by the sub-tier change content calculation processing 128.

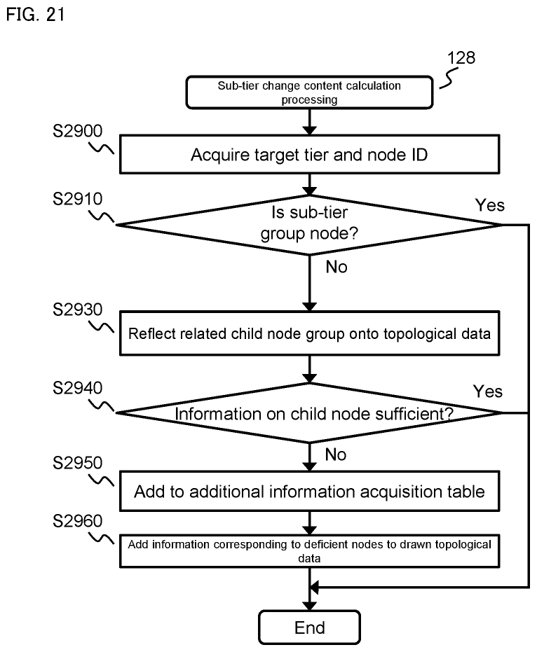

FIG. 21 is a flow chart showing an example of the sub-tier change content calculation processing 128 in the topological map presentation system 1 according to the present embodiment. The sub-tier change content calculation processing 128 is processing of selecting, with respect to a designated node, a child node group thereof to be displayed on a topological map and reflecting the child node group onto topological data.

When the event analysis processing unit 121 receives a node to be a target (S2900), the event analysis processing unit 121 first refers to topological data and determines whether or not a child node of the target node is a group node that has been grouped (S2910). In addition, when the event analysis processing unit 121 determines that the child node of the target node is a group node (Yes in S2910), since the child node of the target node is in a state where detailed information is intentionally not displayed on the topological map due to grouping, the processing is ended without performing further node expansion.

In contrast, when the event analysis processing unit 121 determines that the child node of the target node is not a group node (No in S2910), the event analysis processing unit 121 must display a child node group of the node designated in S2900 on the topological map. To this end, the event analysis processing unit 121 refers to the condition field T1104 of the group node data management table T110, determines whether or not there is a row satisfying conditions that the node group belongs to a tier to which the child node belongs, the node group relates to (the node group is a child node of) the target node, and Feature is the same, and when the row is present, the event analysis processing unit 121 reflects information on the node included in the member node ID T1103 onto topological data (S2930).

At this point, when a node satisfying the conditions in S2930 is absent or when a node satisfying the conditions in S2930 is present but the all-already-acquired flag T1105 of the row is False (No in S2940), the event analysis processing unit 121 must acquire data of insufficient nodes from the topological configuration management server 200. Therefore, the event analysis processing unit 121 creates a data acquisition request with a same content as the conditions used in S2930 and stores the data acquisition request in the request item management table T170 (S2950). In addition, the event analysis processing unit 121 reflects information of a temporary node indicating a content of the request item created in S2950 onto topological data (S2960).

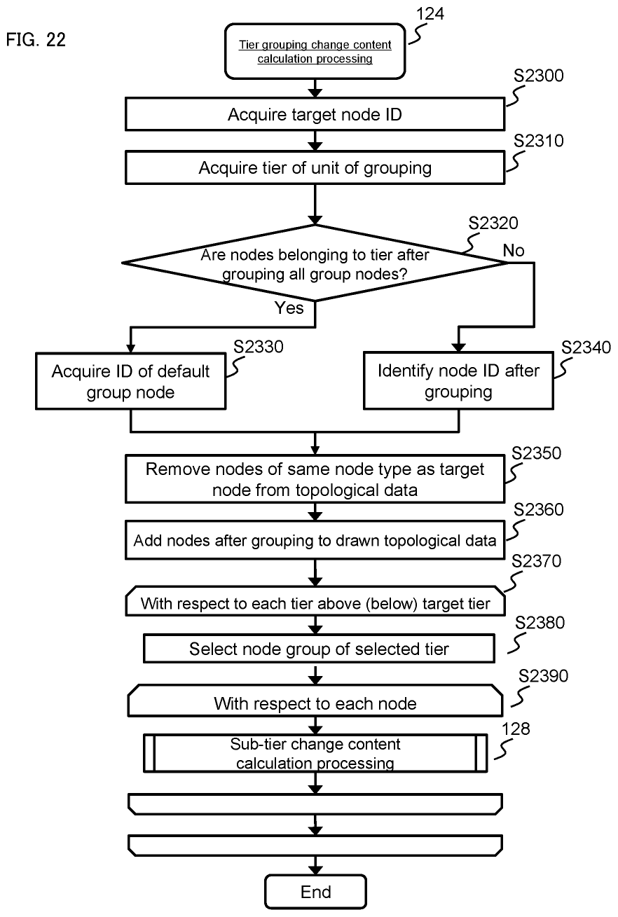

FIG. 22 is a flow chart showing an example of the tier grouping change content calculation processing 124 in the topological map presentation system 1 according to the present embodiment. The tier grouping change content calculation processing 124 is processing of grouping node groups in tier units.

The event analysis processing unit 121 receives a node to be a target and a tier of a unit to be organized as a group and starts processing (S2300, S2310). For example, as shown in FIG. 2, an Application node may be organized into a group node of “Applications” or “BUs & Applications”. In this manner, since there may be a plurality of units of tiers to be organized as a group with respect to a single node, for example, an operation for selecting a tier of a unit to be grouped may be performed by selecting a node with a right-click or the like on the UI unit 110.

Next, with respect to the grouping unit tier received in S2310, the event analysis processing unit 121 refers to the tier definition table T150 and determines whether or not the affiliated node type T1504 of all nodes is a group node (S2320). When it is determined that the nodes are all group nodes (Yes in S2320), since a group node after grouping is expected to behave so as to be expanded to a default group node upon expansion (for example, Locations is expanded to Countries, Cities, and DCs), the event analysis processing unit 121 acquires a value of the node ID T1102 of the group node which is configured as an initial value in the group node data management table T110 (S2330).

In contrast, when the event analysis processing unit 121 determines that a node that is not a group node is included (No in S2320), the event analysis processing unit 121 refers to the group node data management table T110 and determines whether or not there is a row of which the condition field T1104 matches a condition of being a node group that is a grouping target and which the all-already-acquired flag T1105 is True. When there is such a row, a value of the node ID T1102 of the row is acquired in order to avoid holding overlapping information. When there is no such row, a node ID of the group node is newly numbered and added to the group node data management table T110 (S2340). At this point, since the client 100 may not hold all nodes of the target tier, the all-already-acquired flag T1105 is changed to False.

Next, the event analysis processing unit 121 removes information of all of the nodes belonging to the tier to be grouped from the topological data (S2350) and, instead, reflects information of the group node identified in S2330 and S2340 onto the topological data (S2360).

Subsequently, the event analysis processing unit 121 recalculates a sub-topology of child and subsequent nodes. This is because, while nodes related to each node were displayed as child nodes prior to the grouping operation, due to the nodes being grouped in tier units, a constraint that child nodes are related to a specific node no longer applies. The event analysis processing unit 121 executes S2370 to S2390 and the sub-tier change content calculation processing 128 with respect to each tier subsequent to the node that is the operation target. Since these processes are similar to S2170 to S2190 of the node expansion change content calculation processing 123, a detailed description will be omitted.

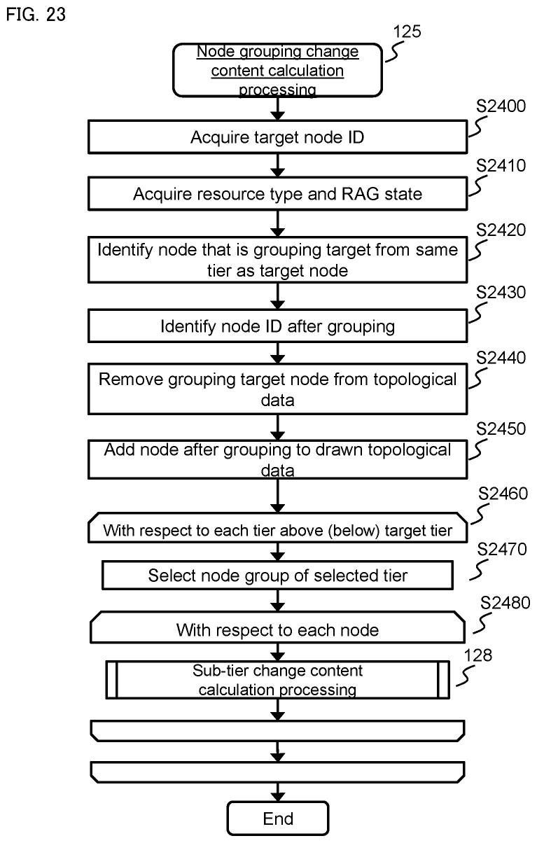

FIG. 23 is a flow chart showing an example of the node grouping change content calculation processing 125 in the topological map presentation system 1 according to the present embodiment.

The node grouping change content calculation processing 125 is processing of grouping a plurality of node groups under the tier organized in the tier grouping change content calculation processing shown in FIG. 22. In the present embodiment, a flow of grouping nodes in units of RAG states will be described as a representative example.

The event analysis processing unit 121 receives a node to be a target and starts processing (S2400). First, the event analysis processing unit 121 acquires various types of state information such as a resource type and performance of the target node from the node data management table T100, refers to the criteria management table T160, and obtains a RAG state in a criterion corresponding to a present Feature (S2410). In addition, as a node group that is a grouping target, the event analysis processing unit 121 selects nodes of a same resource type and a same RAG state from topological data (S2420).

Next, the event analysis processing unit 121 refers to the group node data management table T110 and determines whether or not there is a row of which the condition field T1104 matches a condition of being anode group of the grouping target and which the all-already-acquired flag T1105 is True. When there is such a row, a value of the node ID T1102 of the row is acquired in order to avoid holding overlapping information. When there is no such row, a node ID of the group node is newly numbered and added to the group node data management table T110 (S2430).

Next, the event analysis processing unit 121 removes information of the node group to be grouped from the topological data (S2440) and, instead, reflects information of the group node identified in S2430 onto the topological data (S2450).

Subsequently, the event analysis processing unit 121 recalculates a sub-topology of child and subsequent nodes. In other words, the event analysis processing unit 121 executes S2460 to S2480 and the sub-tier change content calculation processing 128 with respect to each tier subsequent to the node that is the operation target. Since these processes are similar to S2170 to S2190 of the node expansion change content calculation processing 123, a detailed description will be omitted. It should be noted that, as child nodes of the group node that has been grouped, child nodes of the node group prior to the operation may be aligned without overlapping.

While a case where nodes are grouped in units of RAG states has been described as a representative example in the present embodiment, a configuration may be adopted in which nodes can be grouped in arbitrary units. For example, in such a case, a user may be asked to select a plurality of nodes to be grouped on the UI unit 110 by a mouse selection or the like, and by receiving information on the node group in the processing of S2400, information on a node group that is a grouping target such as that shown in S2420 may be acquired. In addition, in such a case, as the RAG of a group node, a plurality of RAG states may be displayed in an integrated manner by a method such as displaying a worst value.

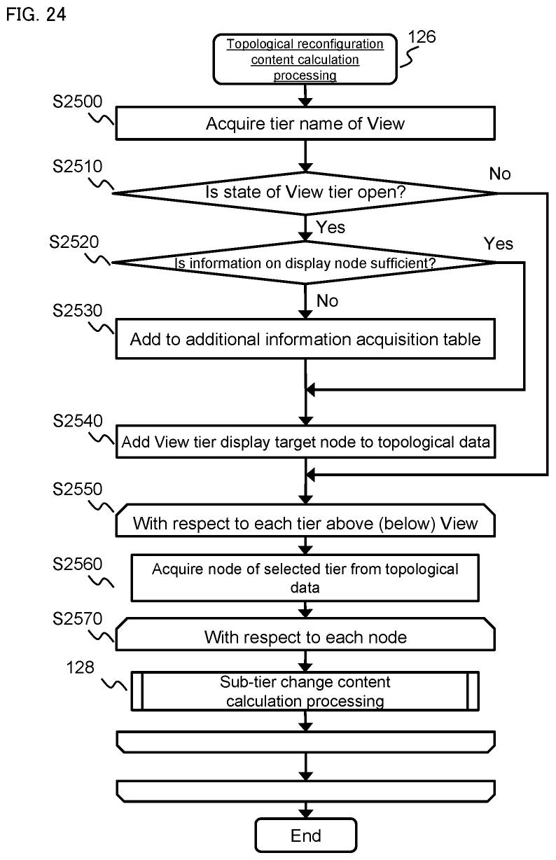

FIG. 24 is a flow chart showing an example of the topological reconfiguration content calculation processing 126 in the topological map presentation system 1 according to the present embodiment.

The topological reconfiguration content calculation processing 126 is processing of reconfiguring topology when changing View, when changing Feature, when redrawing the UI unit 110 and updating a topological map, and the like.

The event analysis processing unit 121 receives a View tier name and starts processing (S2500). First, the event analysis processing unit 121 updates topological data with respect to nodes of the View tier. The event analysis processing unit 121 first refers to the tier expanded state management table T120 and determines whether or not the View tier is in an Open state (S2510). When the event analysis processing unit 121 determines that the View tier is in an Open state (Yes in S2510), since the nodes displayed in the View tier are only group nodes and do not change, the event analysis processing unit 121 performs the processing of S2550 without performing the processes of S2520 to S2540.

In contrast, when the event analysis processing unit 121 determines that the View tier is not in an Open state (No in S2510), the event analysis processing unit 121 refers to the group node data management table T110 and determines whether or not there is a row which matches a condition of being a node group belonging to the View tier and Feature being the same. When the event analysis processing unit 121 determines that there is such a row, the event analysis processing unit 121 determines whether or not the all-already-acquired flag 11105 is True (S2520). When the event analysis processing unit 121 determines that the all-already-acquired flag T1105 is not True (No in S2520), since information on nodes must be additionally acquired from the topological configuration management server 200, the event analysis processing unit 121 adds a request for data acquisition to the request item management table T170 on the basis of the condition of S2520 (S2530).

In contrast, when the event analysis processing unit 121 determines that the all-already-acquired flag T1105 is True (Yes in S2520), the event analysis processing unit 121 updates topological data with information of a node with the member node ID T1103 in the relevant row of the group node data management table T110. In addition, when the event analysis processing unit 121 determines that the all-already-acquired flag T1105 is not True in S2520, the event analysis processing unit 121 updates topological data with information of a temporary node corresponding to the data acquisition request added in S2530 (S2540).

Next, the event analysis processing unit 121 reconfigures a sub-topology toward tiers above and below the View tier. In other words, the event analysis processing unit 121 executes S2550 to S2570 and the sub-tier change content calculation processing 128 with respect to each tier. Since these processes are similar to S2170 to S2190 of the node expansion change content calculation processing 123, a detailed description will be omitted.

As described above, the event analysis processing unit 121 calculates a topological configuration change upon occurrence of an operation event, updates topological data, and adds a data acquisition request item of additionally necessary data to the request item management table T170. Subsequently, the client 100 communicates with the topological configuration management server 200 to notify a content of the operation even and update of topological data, and transmits a data acquisition request. Upon receiving the data, the topological configuration management server 200 executes the topological data creation processing unit 201 and creates topological data after acquisition of the additional data.

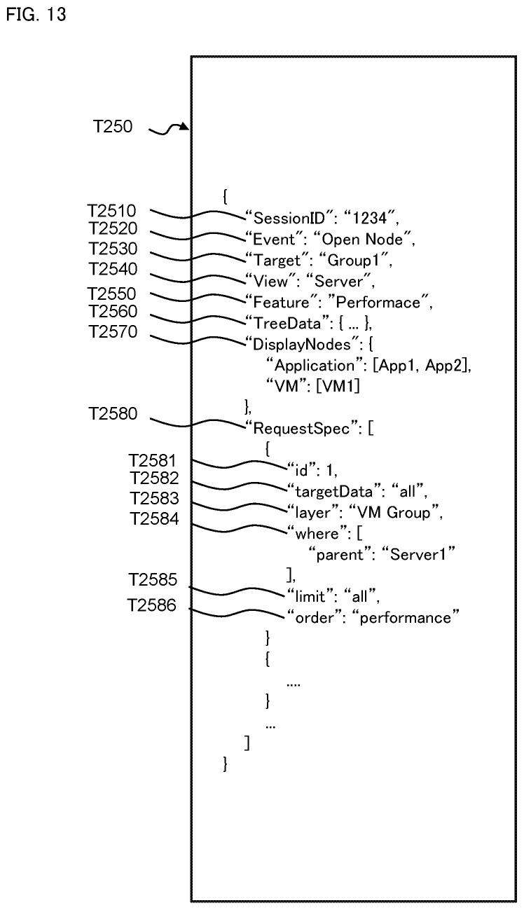

FIG. 13 is a diagram showing an example (JSON format) of data T250 that is transmitted when requesting additional data from the topological configuration management server 200 according to the present embodiment.

The data T250 has a session ID T2510, a content T2520 of an operation event, a node name T2530 of an operation target, a View tier name T2540, a Feature name T2550, topological data T2560, a display node T2570, and a request item T2580.

The topological data T2560 is the same as the data shown in FIG. 12. In addition, the display node T2570 indicates a node group which is in focus and which is drawn in the topology displayed on the UI unit 110. This is a portion which is currently being referred to by the user in the topological map and which is a highly important portion from the perspective of UX.

The request item ID T2580 has a similar content to the request item management table T170. An ID T2581 corresponds to the request ID T1702, “Target data” T2582 corresponds to the target data T1703, “Layer” T2583 corresponds to the tier T1704, “Where” T2584 corresponds to the constraint T1705, “Limit” T2585 corresponds to the quantity T1706, and “Order” T2586 corresponds to the alignment order T1707.

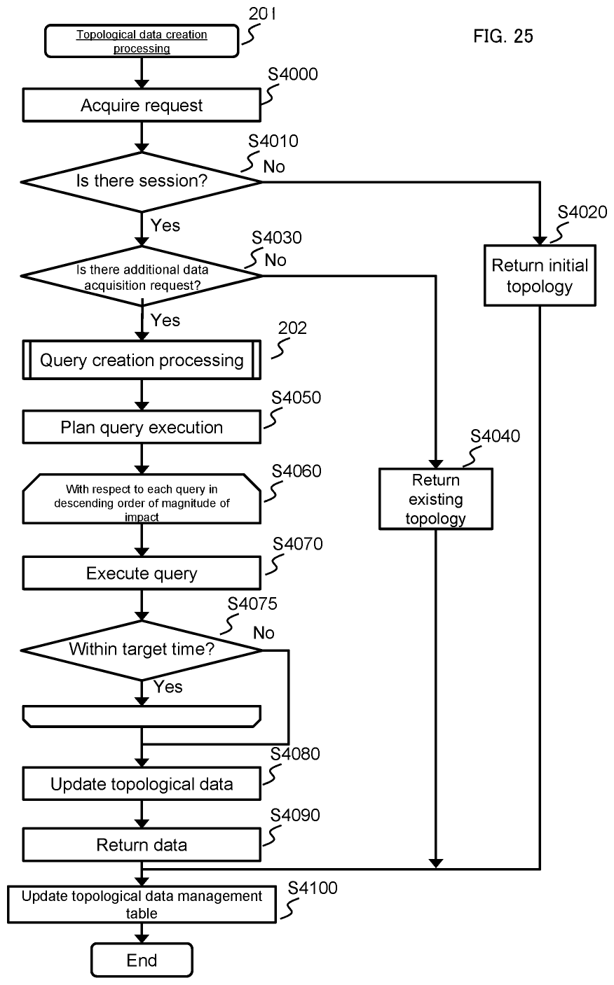

FIG. 25 is a flow chart showing an example of operations by the topological data creation processing unit 201 included in the topological configuration management server 200 in the topological map presentation system 1 according to the present embodiment.

The topological data creation processing unit 201 receives the data T250 from the client 100 and starts processing (S4000). First, the topological data creation processing unit 201 refers to the “Session ID” T2410 of the received data and determines whether or not a relevant value is stored in the topological data management table T240 and, if so, whether or not the value is a valid value such as a value within a validity period (S4010). In addition, when a negative determination is made (No in S4010), the topological data creation processing unit 201 returns, as initial data, topological data constituted by group nodes (“Locations”, “BUs & Applications”, and “IT Infrastructures”) which are grouped in units of a widest range (S4020). This is done in order to restore a topological map that can accommodate various use cases of the user to an initial state.

In contrast, when a positive determination is made (Yes in S4010), the topological data creation processing unit 201 further refers to “Request Spec” T2480 and determines whether or not there is an acquisition request for data (S4030). When the topological data creation processing unit 201 determines that there is no acquisition request for data (No in S4030), the topological data creation processing unit 201 does not make any particular change to the topological data and returns the received “Topology Data” T2460 without modification (S4040).

In contrast, when the topological data creation processing unit 201 determines that there is an acquisition request for data (Yes in S4030), the topological data creation processing unit 201 performs additional data acquisition and updates and returns the topological data.

First, the topological data creation processing unit 201 executes query creation processing 202 of which details will be provided later, creates a plurality of data acquisition query sets corresponding to the data acquisition request, and stores the data acquisition query sets in the query management table T200. Basically, when acquiring data from a DB, the larger an amount of data to be acquired, the more complicated the queries to be executed, and the larger the number of queries to be executed, the longer the time necessary for data acquisition. The longer the time necessary for data acquisition, the longer the time necessary for screen updates on the UI unit 110, which results in a drop in usability. However, the smaller the amount of information to be acquired, the smaller the amount of information that can be displayed on the topological map after the update, which undermines effectiveness as a topological map. Therefore, in the query creation processing 202, query sets of a plurality patterns with different degrees of decline of effectiveness (hereinafter, referred to as an impact) and different execution time estimates due to amounts of data that can be acquired are generated.

Next, the topological data creation processing unit 201 creates a combination of data acquisition query sets with respect to each data acquisition request which is a query group that ends within a target response time with respect to the client 100 and which minimizes impact (S4050). For example, the combination of data acquisition query sets may be calculated using a known combination optimization algorithm.

Next, the topological data creation processing unit 201 executes queries and acquires data. Specifically, the topological data creation processing unit 201 executes each query in sequence from a query set with a large impact and acquires data from a DB (S4060, S4070). At this point, when an elapsed time from the start of execution of the topological data creation processing exceeds the target response time, the topological data creation processing unit 201 cancels execution of subsequent queries (S4075).

Subsequently, the topological data creation processing unit 201 updates the topological data to a complete piece of topological data by replacing each temporary node included in “Topology Data” T2460 with corresponding acquired data and returns the complete topological data to the client 100 (S4080, S4090).

Finally, the topological data creation processing unit 201 updates the topological data management table with the topological data to be returned and ends the processing (S4100).

Accordingly, the topological data creation processing unit 201 can limit an update time of GUI due to data acquisition to a certain time or less while minimizing an amount of information that can be displayed by a topological map to the greatest extent possible.

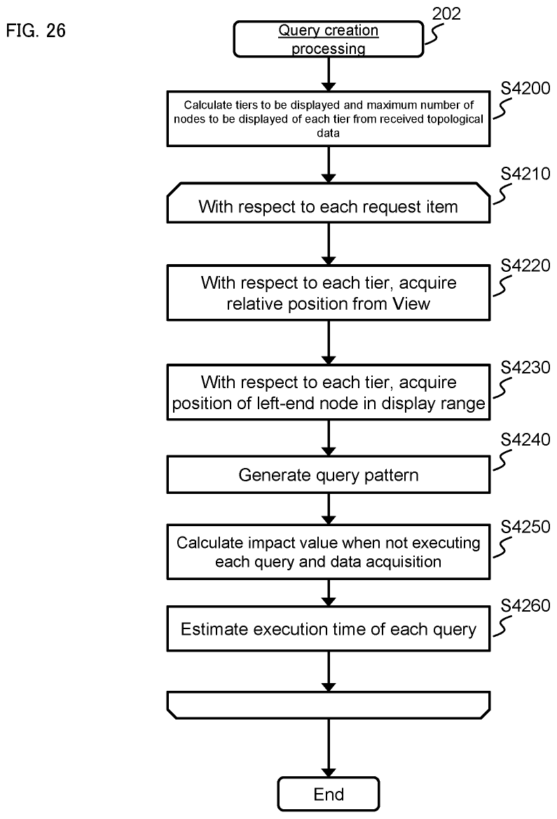

FIG. 26 is a flow chart showing an example of the query creation processing 202 in the topological map presentation system 1 according to the present embodiment. The query creation processing 202 is processing of generating a plurality of data acquisition queries with different acquired data amounts with respect to a data acquisition request and estimating an impact when executing each query.

Basically, although it is best if all pieces of data matching a requested condition are returned, when returning all of the pieces is unrealistic in terms of processing time, it is conceivably acceptable to display a part of the nodes in a grouped manner. In this case, when the user's interest is directed toward a node that has been grouped, since a need to perform an operation once again arises, it can be said that an impact has occurred due to a reduction in the data acquisition amount. In addition, it is conceivable that, the closer to an area displayed on the UI unit 110 by the user, the greater the likelihood of occurrence of a follow-up operation and the greater the impact of reducing a data acquisition amount with respect to a node in such an area.

Furthermore, the closer the tier in which a group node is formed to View, the smaller the size of a sub-topology of the group node and thereafter and the smaller the amount of information that can be displayed on a topological map. Therefore, the closer the tier is to View, the greater the impact of reducing a data acquisition amount.

For this reason, the query creation processing 202 calculates an impact value of each query set as a product of a base value of each query, a distance (a) from. View of a target tier, and a distance (b) from a left end of a display area range of temporary nodes in the tier.

Impact value=base value of each query*a

First, as reference data for calculating the impact value, the topological data creation processing unit 201 calculates tiers to be displayed on a topological map and the number of nodes to be displayed on each tier from the received topological data (S4200).

In addition, the topological data creation processing unit 201 executes S4220 to S4260 with respect to each request item and calculates a corresponding query set and an impact thereof (S4210).

First, the topological data creation processing unit 201 calculates the distance (a) from View of the target tier (S4220). The closer to the View tier, the larger the value of (a) of each tier. An example of a calculation method involves obtaining an inverse number of a distance from View of the target tier as shown below.

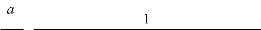

In the case of the calculation formula given above, for example, a=1 when the View tier itself is a target and a=1/3 when a tier that is higher than View by two tiers or more. It should be noted that the calculation method described above is a simple example and the value of a may be calculated according to an arbitrary probability distribution such as a normal distribution, or weighting may be applied so that a specific tier has a larger value of a. For example, in this case, the weight may vary depending on a configuration of View.

Next, the topological data creation processing unit 201 calculates the distance (b) from the left end of a display area range of temporary nodes in the tier (S4230). Basically, the greater a distance from a node at the left end of the display area range of a same tier as a temporary node, the smaller the value of b of the temporary node. An example of a calculation method involves obtaining an inverse number of a distance between a temporary node and the node at the left end of the display area range as shown below.

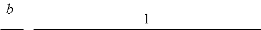

In the case of the calculation formula given above, for example, when a temporary node is present at a position separated by three nodes toward the right from the node at the left end of the display area range, b=1/4. It should be noted that the calculation method described above is a simple example and other calculation methods similar to that in S4220 may be used. For example, weights when determining the value of b depending on whether or not anode is within the display area range may be differentiated.

Next, the topological data creation processing unit 201 creates a plurality of data acquisition queries with different data acquisition ranges (S4240). Examples of a creation pattern of queries include patterns (1) to (4) presented below.

(1) Acquire all information with respect to all resources matching a required condition.

(2) Acquire all information with respect to top ten resources among resources matching a required condition. For other resources, acquire only information on the number of resources for each RAG state so that the number of resources can be displayed when grouped according to RAG states.

(3) Acquire all information with respect to top ten resources among resources matching a required condition. Also acquire information on the number of resources so that the number of resources can be displayed when other resources are grouped.

(4) No information is acquired.

The topological data creation processing unit 201 creates a query of each pattern on the basis of a value of a designated request item. A specific query example is as represented by the query T2004 of the query management table T200 shown in FIG. 14. In addition, a value determined in advance may be used as the basis impact value of each query as represented by the impact value T2006. In the example shown in FIG. 14, since all of the pieces of request data are acquired in pattern (1), the impact value is 0, and since there is no request data in pattern (4), the impact value is 100. The patterns (2) and (3) are values configured within a range of 0 to 100.

Next, the topological data creation processing unit 201 calculates the impact value of each query on the basis of the basic impact value calculated in S4220 to S4240 and the values of a and b (S4250).

In addition, the topological data creation processing unit 201 calculates an estimate of an execution time of each query (S4260). As a calculation method thereof, for example, the topological data creation processing unit 201 refers to the query execution history management table T230 shown in FIG. 16 which is an execution record of previous queries, identifies an execution time of a previous query result of which a query content is similar and the number of table rows corresponding to the execution, and estimates, from the data, a function expression having the number of table rows as an input and the execution time as an output. In addition, using the estimated function expression, a query execution time is estimated from the present number of table rows. As an estimation system of the function expression, for example, a known regression analysis method may be used.

Finally, the topological data creation processing unit 201 stores a query set corresponding to the request item in the query management table T200 together with the impact value and the execution time estimate calculated in S4250 and S4260.

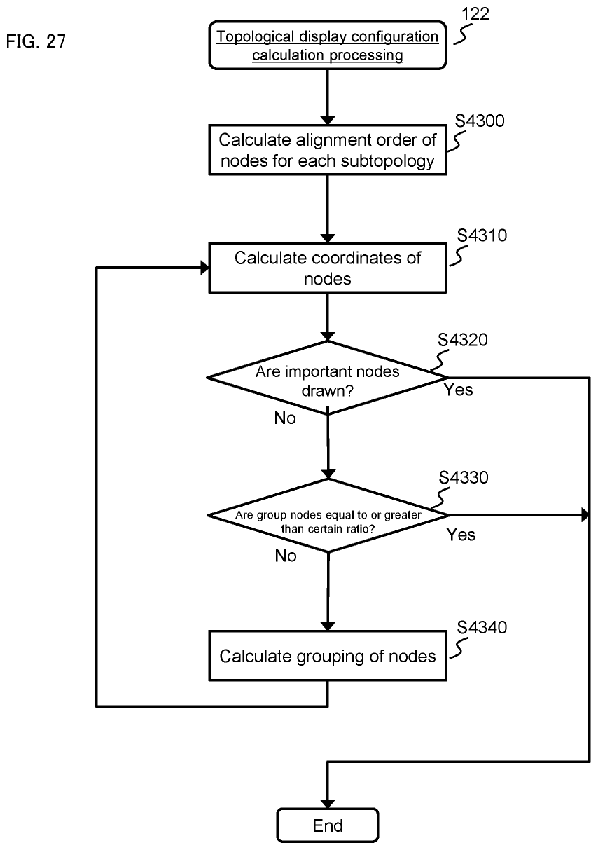

FIG. 27 is a flow chart showing an example of operations by the topological display configuration calculation processing unit 122 in the topological map presentation system 1 according to the present embodiment.

The topological display configuration calculation processing unit 122 calculates a configuration of a topological map to be displayed on the UI unit 110 on the basis of topological data received from the topological configuration management server 200. In doing so, the topological display configuration calculation processing unit 122 calculates an alignment order of nodes or a grouping range so that a node with a high significance is displayed within the display screen 115 of the UI unit 110.

The topological display configuration calculation processing unit 122 first aligns the respective nodes included in topological data in a descending order of significance so that a child node group of a same parent node is aligned from the left in a descending order of significance for each tier from the View tier toward upper and lower tiers (S4300).

Next, the topological display configuration calculation processing unit 122 calculates display coordinates on the UI unit 110 with respect to each of the nodes of the topological data (S4310). As a calculation method of coordinates, for example, when a topological map is initially displayed, a node with highest significance in the View tier is selected as a reference node, when an operation with respect to a node is performed, the node that is an operation target is selected as a reference node, but otherwise a node that is closest to a center of the display screen 115 is selected as a reference node, in which case coordinates of each node is calculated on the basis of the position of the reference node.

The topological display configuration calculation processing unit 122 first configures coordinates of the reference node at a position prior to redraw or at a certain position in the case of an initial draw, next arranges nodes related upward and downward from the reference node so as to be separated at certain intervals, and repetitively performs adjustments until reaching a leaf node to calculate coordinates of nodes constituting a sub-tree. Next, nodes to the left and the right of the reference node are arranged so as not to overlap with the sub-tree calculated earlier and, in a similar manner, calculates an arrangement of related upper and lower nodes to calculate coordinates of nodes constituting the sub-tree. This processing is performed with respect to all nodes on a same tier as the reference node to calculate the coordinates of each node.

Next, the topological display configuration calculation processing unit 122 performs calculations for grouping nodes so that nodes with high significance are included in the display area range and omitting sub-topologies with relatively low significance. Omitting a sub-topology refers to grouping one or a plurality of nodes having a same node as a parent and hiding a sub-topology constituted by descendant nodes thereof. In this case, the display area range may be an area in focus on the UI unit 110 or an area including an area that is reached by scrolling by a certain amount from the area in focus.

Next, the topological display configuration calculation processing unit 122 normalizes significances of nodes for each tier to enable the significances of all nodes to be comparable. In addition, the topological display configuration calculation processing unit 122 determines, for example, whether or not five nodes in a descending order of significance are included in the display area range (S4320). When a positive determination is made (Yes in S4320), the topological display configuration calculation processing unit 122 determines that important nodes are being displayed at a position easily-noticeable by the user and ends the processing.

In contrast, when a negative determination is made (No in S4320), the topological display configuration calculation processing unit 122 next determines whether not a proportion of group nodes among node groups included in the display area range is, for example, 20% or higher (S4330). When the topological display configuration calculation processing unit 122 determines that the proportion of group nodes is a certain ratio or higher (Yes in S4330), there is a possibility that a further increase in group nodes may reduce the number of ordinary nodes, thereby preventing a detailed relation between nodes in a topology from being displayed and causing the user to become incapable of making a specific determination. For this reason, the topological display configuration calculation processing unit 122 ends the processing without increasing group nodes. It should be noted that appropriate values of the thresholds exemplified in S4320 and S4330 may differ depending on the user or the like and may be variable.

In contrast, when the topological display configuration calculation processing unit 122 determines that the proportion of group nodes is lower than the constant ratio (No in S4330), the topological display configuration calculation processing unit 122 selects a sub-topology to be omitted in order to include, in the display area range, a node with a highest significance among the nodes not included in the display area range (S4340). An example of a calculation method is a method of solving a combination optimization problem for obtaining a combination of omitted nodes that minimizes a sum of significances of node groups of an omitted sub-topology among a topological configuration in which the selected node is included in the display area range.

Finally, the topological display configuration calculation processing unit 122 reflects grouping of nodes for omitting the node calculated in S4330 onto topological data and causes a transition of the processing to S4310.

<Effect of Topological Map Presentation System According to Embodiment>

According to the present embodiment configured as described above, on the basis of an input accepted by the UI unit 110 of a designation of a tier to be a reference, the display processing unit 120 causes the display screen 115 of the UI unit 110 to display a topological map in which, from at least one node included in the designated tier, nodes related to the node are displayed in upward and downward directions of the display screen 115.

Therefore, it is possible to readily oversee and comprehend a state of the entire IT system while changing perspectives and resources of interest even when the number of resources increases.

In addition, on the basis of an input of a selection and an input of a designation of a tier accepted by the UI unit 110 with respect to a perspective (Feature) of consideration based on the topological map, the display processing unit 120 calculates, on the basis of an evaluation criterion determined in advance, a significance that represents a degree of a state of a resource and changes and displays a display mode of a marker and a display alignment order of nodes on the basis of a degree of the calculated significance.

Therefore, a resource with high significance can be preferentially brought into focus while comprehending the entire topological map.

It is to be understood that the present invention is not limited to the embodiments described above and is intended to cover various modifications. For example, the embodiments presented above have been described in detail in order to provide a clear understanding of the present invention, and the present invention is not necessarily limited to embodiments including all of the components described above. In addition, a part of components of a certain embodiment can be replaced with components of another embodiment, and components of another embodiment can be added to components of a certain embodiment. Furthermore, a part of the components of each embodiment can be added to, deleted from, or replaced with other components.

Moreover, the respective components, functions, processing units, processing means, and the like described above may be partially or entirely realized by hardware by, for example, designing with integrated circuits or the like. In addition, each component, function, and the like described above may be realized by software by having a processor interpret and execute a program that realizes each function. Information such as a program, a table, a file, and the like that realizes each function can be placed in a recording apparatus such as a memory, a hard disk, or an SSD or in a recording medium such as an IC card, an SD card, or a DVD.

In addition, the control lines and information lines shown are those considered necessary for purposes of illustration and do not necessarily represent all control lines and information lines of a product. In reality, almost all components may be considered to be mutually coupled.

What is claimed is:

1. A topological map presentation system, comprising:
a management server configured to possess configuration information and state information of a plurality of resources that are related to each other;
a display processing apparatus configured to cause, on the basis of the configuration information and the state information possessed by the management server, a user interface apparatus to display a topological map having resources as nodes and connecting the nodes with lines on the basis of relations among the resources; and
the user interface apparatus which displays the topological map on a display screen, wherein
the topological map provides a tiered display of each node at a height on the display screen which is determined for each resource type,
the user interface apparatus is configured to accept a designation input of a tier to be a reference, and
the display processing apparatus is configured to cause the topological map to be displayed on the display screen, the topological map displaying, from at least one of the nodes included in the tier designated by the designation input, nodes related to the node in upward and downward directions of the display screen.

2. The topological map presentation system according to claim 1, wherein
the topological map further displays a marker indicating a state of the resource as load information of the node,
the user interface apparatus is configured to accept a selection input of a perspective of consideration based on the topological map, and
the display processing unit is configured to calculate, a significance that represents a degree of a state of the resource on the basis of the selection input and the designation input, and on the basis of an evaluation criterion determined in advance, and change and display a display mode of the marker and a display alignment order of the node on the basis of a degree of the significance.

3. The topological map presentation system according to claim 2, wherein
the selection input is a capacity planning for the purpose of preventing a deficiency in performance of the resource at a future time point,
the designation input is the tier when the resource is an application, and
the evaluation criterion is a response time prediction of the resource at a future time point when the tier is the application and a continuation time during which a threshold of a performance abnormality determination of the resource is exceeded at a future time point when the tier is a server.

4. The topological map presentation system according to claim 2, wherein
the selection input is a capacity planning for the purpose of preventing a deficiency in performance of the resource at a future time point,
the designation input is the tier when the resource is a server, and
the evaluation criterion is a remaining time until a threshold of a performance abnormality determination of the resource is exceeded and a magnitude of a performance value of an element constituting the server when the tier is the server and a response time prediction of the resource at a future time point when the tier is an application.

5. The topological map presentation system according to claim 2, wherein
the user interface apparatus is configured to group a plurality of the nodes or further accept an operation input for expanding the nodes that have been grouped, and
the display processing apparatus is configured to cause, when updating the topological map upon the user interface apparatus accepting the designation input, the selection input, or the operation input or by performing an initialization operation, the user interface apparatus to display the topological map which uses a prescribed area in the display screen as a display area and which groups the nodes by omitting display thereof such that a prescribed number of the nodes with higher levels of the significance are included inside the display area.

6. The topological map presentation system according to claim 5, wherein
the display processing apparatus is configured to cause, when updating the topological map upon the user interface apparatus accepting the designation input, the selection input, or the operation input or by performing the initialization operation, the user interface apparatus to display the topological map which groups the nodes by omitting display thereof such that the nodes grouped inside the display area are under a prescribed ratio.

7. The topological map presentation system according to claim 5, wherein
the display processing apparatus is configured to request, when updating the topological map upon the user interface apparatus accepting the designation input, the selection input, or the operation input or by performing the initialization operation, the management server to acquire data necessary for updating the topological map, and
the management server is configured to generate, when there is a data acquisition request from the display processing apparatus, a plurality of data acquisition queries with different data acquisition ranges on the basis of the data acquisition request, calculate an amount of reduction of an information amount of the topological map when the display processing apparatus updates the topological map on the basis of the data acquired based on the data acquisition queries, and execute the data acquisition query that minimizes the amount of reduction of the information amount and send the data to the display processing apparatus.

8. The topological map presentation system according to claim 7, wherein
the management server is configured to estimate an execution time of a plurality of the data acquisition queries, execute the data acquisition query which is expected to end within a target response time for sending the data to the display processing apparatus and which minimizes the amount of reduction of the information amount, and send the data to the display processing apparatus.

9. The topological map presentation system according to claim 8, wherein
the management server is configured to execute the data acquisition queries in an ascending order of the amount of reduction of the information amount and not to execute subsequent data acquisition queries once the target response time elapses.

10. The topological map presentation system according to claim 7, wherein
the amount of reduction of the information amount is a value that increases when a distance in the display screen between the tier that is a target of the data acquisition request and the tier corresponding to the designation input increases.

11. The topological map presentation system according to claim 7, wherein
the amount of reduction of the information amount is a value that increases when a distance between the node that is a target of the data acquisition request and end parts in leftward and rightward directions of the display area increases.

12. The topological map presentation system according to claim 7, wherein
the display processing apparatus comprises:
an event analysis processing unit configured to identify, on the basis of an input accepted by the user interface apparatus, a content of a change to a structure of the topological map and the data acquisition request to be sent to the management server; and
a topological display configuration calculation processing unit configured to calculate a range of nodes to be grouped by omitting display of the node and a display position of the node in the display area on the basis of the data sent from the management server.

13. The topological map presentation system according to claim 12, wherein
the management server includes a topological data creation processing unit configured to generate a plurality of the data acquisition queries on the basis of the data acquisition request, execute the data acquisition query which minimizes the amount of reduction of the information amount, and send the data to the display processing apparatus.

14. A topological map presentation method executed by a topological map presentation system including a management server which possesses configuration information and state information of a plurality of resources that are related to each other, a user interface apparatus having a display screen, and a display processing apparatus, the topological map presentation method comprising:
displaying, on the display screen, a topological map which uses the resources as nodes and connects the nodes with lines on the basis of relations among the resources based on the configuration information and the state information possessed by the management server and which displays the node in a tiered manner at a height on the display screen determined for each type of the resource; and
accepting a designation input of a tier to be a reference, wherein
displaying a topological map further includes displaying, on the display screen, the topological map in which, from at least one of the nodes included in the tier designated by the designation input, the nodes related to the node are displayed in upward and downward directions of the display screen.

15. A non-transitory computer readable recording medium storing computer program to be executed by a computer coupled to a user interface apparatus having a display screen, the computer program realizing:
a topological map display function of displaying, on the display screen, a topological map which, on the basis of configuration information and state information of a plurality of resources that are related to each other possessed by a management server, uses the resources as nodes and connects the nodes with lines on the basis of relations among the resources and which displays the node in a tiered manner at a height on the display screen determined for each type of the resource; and
a tier designation input function of accepting a designation input of the tier to be a reference, wherein
the topological map display function further includes a function of displaying, on the display screen, the topological map in which, from at least one of the nodes included in the tier designated by the designation input, the nodes related to the node are displayed in upward and downward directions of the display screen.
